(19) United States
(12) Patent Application Publication
(10) Pub. No.: US 2026/0107201 A1
(43) Pub. Date: Apr. 16, 2026

(54) BWP and L1-L2 Inter-Cell Mobility

(71) Applicant: Telefonaktiebolaget LM Ericsson (PUBL), Stockholm (SE)

(72) Inventors: Icaro Leonardo Da Silva, SOLNA (SE); Claes Tidestav, BÅLSTA (SE); Antonino Orsino, KIRKKONUMMI (FI); Venkatarao Gonuguntla, SUNDBYBERG (SE)

(21) Appl. No.: 19/115,859

(22) PCT Filed: Sep. 29, 2023
(86) PCT No.: PCT/SE2023/050965

§ 371 Date: Mar. 27, 2025

Related U.S. Application Data
(60) Provisional application No. 63/412,231, filed on Sep. 30, 2022.

(51) Int. Cl. H04W 36/04; H04B 7/06; H04W 72/0457; H04W 76/20

(52) U.S. Cl. CPC H04W 36/04; H04B 7/06968; H04W 72/0457; H04W 76/20

(57) ABSTRACT

According to some embodiments, a method is performed by a wireless device capable of layer one (L1)/layer two (L2) inter-cell mobility. The method comprises receiving a L1/L2 inter-cell mobility configuration comprising at least one target candidate cell configuration. The at least one target candidate cell configuration comprises one or more bandwidth part (BWP) configurations. The method further comprises obtaining at least one indication of at least one of the BWP configurations of a target candidate cell to be activated; receiving a L1/L2 inter-cell mobility execution command including an indication of one target candidate cell configuration for a target cell; and determining at least one active BWP of the target cell in which the wireless device is to operate in the target cell based on the indicated target candidate cell configuration.

### TECHNICAL FIELD

The present disclosure generally relates to communication networks, and more specifically to bandwidth parts (BWPs) and layer one (L1)/layer two (L2) inter-cell mobility.

### BACKGROUND

Fifth generation (5G) New Radio (NR) wireless networks include the concept of a bandwidth part (BWP), which is related to what is referred to as bandwidth adaptation (BA), wherein a user equipment (UE) receive and transmit bandwidth need not be as large as the bandwidth of the cell and may be adjusted. The BWP width may be changed (e.g., to shrink during period of low activity to save power). The BWP location may move in the frequency domain (e.g., to increase scheduling flexibility). The BWP subcarrier spacing may be changed (e.g. to enable different services).

A BWP refers to a subset of the total cell bandwidth of a cell and BA is achieved by configuring a UE with BWP(s) and indicating to the UE which of the configured BWPs is currently the active one.

FIG. 1 is a time frequency diagram illustrating an example of bandwidth adaptation with configuration of three different BWPs. The vertical axis represent frequency and the horizontal axis represents time. BWP1 has a width of 40 MHz and subcarrier spacing of 15 KHz. BWP2 has a width of 10 MHz and subcarrier spacing of 15 KHz. BWP3 has a width of 20 MHz and subcarrier spacing of 60 KHz.

To enable BA on a primary cell (PCell), or more generally to a special cell (SpCell), a gNB configures the UE with uplink and downlink BWP(s), such as in the SpCell configuration (e.g., SpCellConfig). To enable BA on SCells for carrier aggregation (CA), the gNB configures the UE with downlink BWP(s) at least (i.e., there may be none in the uplink). For the PCell, the BWP used for initial access is configured via system information. For the SCell(s), the BWP used after initial activation is configured via dedicated Radio Resource Control (RRC) signaling.

In paired spectrum, downlink and uplink can switch BWP independently. In unpaired spectrum, downlink and uplink switch BWP simultaneously. Switching between configured BWPs happens by means of RRC signaling, downlink control information (DCI), inactivity timer, or upon initiation of random access. When an inactivity timer is configured for a serving cell, the expiry of the inactivity timer associated to that cell switches the active BWP to a default BWP configured by the network. There can be at most one active BWP per cell, except when the serving cell is configured with supplemental uplink (SUL), in which case there can be at most one on each uplink carrier.

To enable reasonable UE battery consumption when BA is configured, only one uplink BWP for each uplink carrier and one downlink BWP or only one downlink/uplink BWP pair can be active at a time in an active serving cell, all other BWPs that the UE is configured with being deactivated. On deactivated BWPs, the UE does not monitor the physical downlink control channel (PDCCH), and does not transmit on physical uplink control channel (PUCCH), physical random access channel (PRACH) and uplink shared channel (UL-SCH).

Layer three (L3) handovers include BWP activation/switching. Beam level mobility, also referred to as beam management procedures, is where a UE changes a beam within a serving cell, e.g., by receiving signaling activating a first transmission configuration indicator (TCI) state, and deactivating a second TCI state, without the need of RRC signaling for such activation/deactivation. The gNB provides via RRC signaling the UE with channel state information (CSI) measurement configuration containing configurations of synchronization signal block (SSB)/CSI resources and resource sets, CSI reports and trigger states for triggering channel and interference measurements and reports. Beam level mobility is then dealt with at lower layers by means of physical layer and medium access control (MAC) layer control signaling, and RRC is not required to know which beam is being used at a given point in time.

SSB-based beam level mobility is based on the SSB associated to the initial downlink BWP and can only be configured for the initial downlink BWPs and for downlink BWPs containing the SSB associated to the initial downlink BWP. For other downlink BWPs, beam level mobility can only be performed based on CSI-RS.

In L3 handovers, the UE receives an RRCReconfiguration message generated by the target gNB (and forwarded by the source gNB) including a ReconfigurationWithSync information element (IE) indicating the target cell. Within the RRCReconfiguration message, the UE receives the information about the downlink and uplink BWPs of the target cell that are to be considered active when the UE accesses the target cell. For the uplink BWP, the field is firstActiveUplinkBWP-Id and for the downlink BWP the field is firstActiveDownlinkBWP-Id, both within the SpCellConfig in spCellConfigDedicated and pointing to BWP configurations within the same IE, as follows:

### 5.3.5.5.7 SpCell Configuration

The UE shall:
[ . . . ]
1> if the SpCellConfig contains spCellConfigDedicated:
[ . . . ]
2> consider the bandwidth part indicated in firstActiveUplinkBWP-Id if configured to be the active uplink bandwidth part;
2> consider the bandwidth part indicated in firstActiveDownlinkBWP-Id if configured to be the active downlink bandwidth part;
   [ . . . ]

### ServingCellConfig Information Element

-- ASN1START
-- TAG-SERVINGCELLCONFIG-START

| | |
|---|---|
| ServingCellConfig ::= | SEQUENCE { |

[...]

| | |
|---|---|
| initialDownlinkBWP | BWP-DownlinkDedicated |

OPTIONAL, -- Need M
[...]

| | |
|---|---|
| firstActiveDownlinkBWP-Id | BWP-Id |

OPTIONAL, -- Cond SyncAndCellAdd
[...]

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M
[...]
}

| | |
|---|---|
| UplinkConfig ::= | SEQUENCE { |
| initialUplinkBWP | BWP-UplinkDedicated |

OPTIONAL, -- Need M

| | |
|---|---|
| uplinkBWP-ToReleaseList | SEQUENCE (SIZE (1..maxNrofBWPs)) OF BWP-Id |

OPTIONAL, -- Need N

| | |
|---|---|
| uplinkBWP-ToAddModList | SEQUENCE (SIZE (1..maxNrofBWPs)) OF BWP-Uplink |

OPTIONAL, -- Need N

| | |
|---|---|
| firstActiveUplinkBWP-Id | BWP-Id |

OPTIONAL, -- Cond SyncAndCellAdd
[...]
}
-- TAG-SERVINGCELLCONFIG-STOP
-- ASN1STOP

[ . . . ]

| Conditional | |
|---|---|
| Presence | Explanation |
| SyncAndCellAdd | This field is mandatory present for a SpCell upon |
| | reconfiguration with reconfigurationWithSync and |
| | upon RRCSetup/RRCResume. |
| | The field is optionally present for a SpCell, Need N, |
| | upon reconfiguration without |
| | reconfigurationWithSync. |
| | The field is mandatory present for an SCell upon |
| | addition, and absent for SCell in other cases, Need M. |

The field firstActiveUplinkBWP-Id, if configured for an SpCell, contains the identifier of the uplink BWP to be activated upon performing the RRC (re-)configuration. If the field is absent, the RRC (re-)configuration does not impose a BWP switch. If configured for an SCell, the field contains the identifier of the uplink bandwidth part to be used upon MAC activation of an SCell. The initial bandwidth part is referred to by BandiwdthPartId=0.

The field firstActiveDownlinkBWP-Id, if configured for an SpCell, contains the identifier of the downlink BWP to be activated upon performing the RRC (re-)configuration. If the field is absent, the RRC (re-)configuration does not impose a BWP switch. If configured for an SCell, the field contains the identifier of the downlink bandwidth part to be used upon MAC activation of an SCell. The initial bandwidth part is referred to by BWP-Id=0. Upon reconfiguration with reconfigurationWithSync, the network sets the firstActiveDownlinkBWP-Id and firstActiveUplinkBWP-Id to the same value.

Third Generation Partnership Project (3GPP) Rel-18 includes a Work Item on further NR mobility enhancements, in particular, in a technical area entitled L1/L2 based inter-cell mobility. The WI description (WID) in RP-213565 includes further details.

According to the WID, when a UE moves from the coverage area of one cell to another cell, at some point a serving cell change needs to be performed. Currently serving cell change is triggered by L3 measurements and is done by RRC signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, to reduce the latency, overhead and interruption time.

L1-L2 inter-cell mobility should be if possible like an inter-cell beam management, i.e., to support L1-L2 inter-cell mobility the UE should be configured to perform measurements on cells that are not the serving cells as defined up to Rel-17.

In Rel-17, to support inter-PCI mTRP operation, a solution has been standardized where a CSI resource may be associated to a physical cell identifier (PCI) that is not the same PCI of one of the serving cells. That solution also requires the UE to receive an explicit indication of which beams (SSBs) and PCIs to be measured for a given reporting configuration.

The goal is to specify a mechanism and procedures of L1/L2 based inter-cell mobility for mobility latency reduction. These include: configuration and maintenance for multiple candidate cells to allow fast application of configurations for candidate cells: a dynamic switch mechanism among candidate serving cells (including SpCell and SCell) for the potential applicable scenarios based on L1/L2 signaling: L1 enhancements for inter-cell beam management, including L1 measurement and reporting and beam indication: timing advance management; and CU-DU interface signaling to support L1/L2 mobility.

The procedure of L1/L2 based inter-cell mobility are applicable to the following scenarios: standalone, CA and NR-DC case with serving cell change within one CG: intra-DU case and intra-CU inter-DU case (applicable for Standalone and CA): both intra-frequency and inter-frequency: both FR1 and FR2; and source and target cells may be synchronized or non-synchronized.

There currently exist certain challenges. For example, one problem is the ability of the UE to determine the active BWP(s), in downlink and uplink to be used in the target cell after a L1/L2 inter-cell mobility execution which leads to a change in the PCell. Without that ability, it is not possible for the UE to perform random access, because the random access configuration (random access channel (RACH) configuration) is defined per uplink BWP, or determine the TCI state to be activated for the downlink (because that is also defined per downlink BW).

The TS 38.300 specifications, partially reproduced above, describe that switching between configured BWPs happens by means of RRC signaling, but L1/L2 inter-cell mobility is a procedure whose execution is triggered by a lower layer signaling, also referred to as L1/L2 signaling in contrast to RRC signaling, referred as L3 signaling. The specification also describes that switching between configured BWPs happens by means of downlink control indication (DCI) or inactivity timer, however, these are defined only for the same cell (intra-cell BWP switching).

Finally, the specifications also describe that switching between configured BWPs happens upon initiation of random access. However, in L1/L2 inter-cell mobility one of the goals is to reduce the interruption time by accessing the target cell without random access.

### SUMMARY

As described above, certain challenges currently exist with bandwidth parts (BWPs) and layer one (L1)/layer two (L2) inter-cell mobility. Certain aspects of the disclosure and their embodiments may provide solutions to these or other challenges. For example, in particular embodiments a user equipment (UE) determines which BWP(s) (e.g., downlink BWP and/or uplink BWP) to consider active in the target cell during L1/L2 inter-cell mobility execution.

According to some embodiments, a method at a UE capable of L1/L2 inter-cell mobility comprises the UE receiving a L1/L2 inter-cell mobility configuration, including a target candidate cell configuration for a target candidate cell. The method further comprises the UE obtaining an indication of a configured BWP(s) of the target candidate cell, and based on the indication the UE determines the configured BWP to be considered active in the target cell upon reception of a L1/L2 inter-cell mobility execution command.

The method further comprises the UE, upon reception of the L1/L2 inter-cell mobility execution command, selecting and using an uplink channel configuration (e.g., physical uplink control channel (PUCCH) configuration, physical uplink shared channel (PUSCH) configuration, and/or random access channel (RACH) configuration, etc.) to access the target candidate cell (e.g., to transmit a scheduling request to obtain a scheduling grant to transmit an uplink message to the target cell to indicate the execution of L1/L2 inter-cell mobility) associated to the uplink BWP indicated to be activated. The UE performs the selection because the UE has multiple configurations for a given uplink channel (e.g., multiple RACH configurations), each associated to one of the multiple uplink BWP(s) of the SpCell configuration. The UE uses the selected uplink channel configuration and transmits an uplink message to the target candidate cell.

The method further comprises the UE, upon reception of the L1/L2 inter-cell mobility execution command, selecting and using at least one uplink spatial relation or spatial direction (of an uplink channel) or uplink transmission configuration indicator (TCI) state to be considered activated (e.g., in the information element (IE) PUCCH-SpatialRelationInfo), wherein the selected uplink spatial relation or spatial direction is associated with the uplink BWP that is indicated to be activated. The selection process is needed because the UE has multiple uplink spatial relation configurations for the target candidate cell, each list associated to one of the multiple uplink BWP(s) of the SpCell configuration. The UE uses the selected uplink spatial direction or uplink TCI state to transmit uplink information to the target candidate cell, as the selected uplink spatial direction indicates a spatial direction in which the UE transmits information from the target candidate cell. In one variant, the UE determines the uplink BWP indicated to be the active one and within that uplink BWP configuration the UE finds an uplink channel configuration (e.g., PUCCH, PUSCH, and/or RACH configuration) and, within the uplink channel configuration the UE finds the list of uplink spatial relation states from which the UE selects the uplink spatial relation of the target cell to consider active for the uplink channel.

In one example, the L1/L2 inter-cell mobility execution command contains a pointer to an uplink spatial relation (e.g., an uplink channel spatial relation identifier, such as pucch-SpatialRelationInfoId) or uplink TCI state that refers to an uplink channel configuration in one of the configured uplink spatial relations in the BWP indicated to be activated. If the UE receives in the L1/L2 inter-cell mobility execution command the uplink spatial relation ID=2 for PUCCH, the spatial relation to consider active for PUCCH is the spatial relation with spatial relation ID=2 configured for PUCCH in the uplink BWP considered to be active upon L1/L2 inter-cell mobility execution. This helps the UE interpret the pointer to an uplink spatial relation included in the L1/L2 inter-cell mobility execution command in the sense that the UE knows in which list to look for the uplink spatial relation, i.e., the list within the uplink BWP considered to be active, resolving the ambiguity.

The method further comprises the UE, upon reception of the L1/L2 inter-cell mobility execution command, selecting and using at least one downlink channel configuration (e.g., physical downlink shared channel (PDSCH) configuration, physical downlink control channel (PDCCH) configuration, control resource set (CORESET) configuration, etc.) for monitoring (receiving) information from the target candidate cell (e.g., to receive downlink control information (DCI) and/or data) associated to the downlink BWP indicated to be activated. The selection process is needed because the UE has multiple configurations for a given downlink channel (e.g., multiple PDCCH configurations), each associated to one of the multiple downlink BWP(s) of the SpCell configuration. The UE uses the selected downlink channel configuration and receives downlink information from the target candidate cell.

The method further comprises the UE, upon reception of the L1/L2 inter-cell mobility execution command, selecting at least one TCI state and consider activated, wherein the selected TCI state(s) are associated with the downlink BWP that is indicated to be activated. The process of selecting is needed because the UE has multiple TCI configuration lists for the target candidate cell, each list associated to one of the multiple downlink BWP(s) of the SpCell configuration. The UE uses the selected TCI state to receive downlink information from the target candidate cell, as the selected TCI state indicates a spatial direction in which the UE receives information from the target candidate cell.

In one variant, the UE determines the downlink BWP indicated to be the active one and within the downlink BWP configuration the UE finds a downlink channel configuration (e.g., PDCCH configuration) and, within the downlink channel configuration the UE finds the list of TCI states from which the UE selects the TCI state of the target cell to consider active for the downlink channel.

In one example, the L1/L2 inter-cell mobility execution command contains a pointer to a TCI state (e.g., a TCI state identifier) that refers to a downlink channel configuration in one of the configured TCI states in the BWP indicated to be activated. If the UE receives in the L1/L2 inter-cell mobility execution command the TCI ID=2 for PDCCH, the TCI state to consider active for PDCCH is the TCI state with TCI state=2 configured for PDCCH in the downlink BWP considered to be active upon L1/L2 inter-cell mobility execution. This helps the UE interpret the pointer to a TCI state included in the L1/L2 inter-cell mobility execution command in the sense that the UE knows in which list to look for the TCI state, i.e., the list within the downlink BWP considered to be considered active, resolving the ambiguity.

The method further comprises the UE, upon reception of the L1/L2 inter-cell mobility execution command, selecting at least one downlink beam (or downlink spatial direction) and considering it to be the one to be monitored, wherein the selected downlink beam(s) is associated with the downlink BWP that is indicated to be activated. The selection process is needed because the UE may have configured downlink beam lists for the target candidate cell, each list associated to one of the multiple downlink BWP(s) of the SpCell configuration. The UE uses the selected downlink beam to receive downlink information from the target candidate cell, as the selected downlink beam indicates a spatial direction in which the UE receives information from the target candidate cell. In one variant, the UE determines the downlink BWP indicated to be the active one and within the downlink BWP configuration the UE finds a downlink channel configuration (e.g., PDCCH configuration) and, within the downlink channel configuration the UE finds the downlink beam list from which the UE selects the downlink beam of the target cell to consider active for the downlink channel.

In one example, the L1/L2 inter-cell mobility execution command contains a pointer to a downlink beam (e.g., a downlink beam identifier) that refers to a downlink channel configuration in one of the configured downlink beams in the BWP indicated to be activated. If the UE receives in the L1/L2 inter-cell mobility execution command the downlink Beam ID=2 for PDCCH (or PDSCH, or both e.g. unified), the downlink beam to consider active for PDCCH (or PDSCH, or both e.g. unified) is the downlink beam with Beam ID=2 configured for PDCCH (or PDSCH, or both e.g. unified) in the downlink BWP considered to be active upon L1/L2 inter-cell mobility execution. This helps the UE interpret the pointer to a downlink beam included in the L1/L2 inter-cell mobility execution command in the sense that the UE knows in which list to look for the downlink beam, i.e., the list within the downlink BWP considered to be active, resolving the ambiguity.

The method further comprises the UE, upon reception of the L1/L2 inter-cell mobility execution command, selecting at least one reference signal (e.g., SSB associated to an SSB index, or CSI-RS resource associated to a CSI-RS identifier) and consider to be the quasi-colocated (QCL) source, i.e., correlated in the spatial domain with a channel (e.g., PDCCH), wherein the selected reference signal is associated with the downlink BWP that is indicated to be activated. The selection process is needed because the UE may have configured reference signal lists for the target candidate cell, each list associated with one of the multiple downlink BWP(s) of the SpCell configuration. The UE uses the selected reference signal to receive downlink information from the target candidate cell, as the selected reference signal indicates a spatial direction correlated with the spatial direction in which the UE receives information from the target candidate cell. In one variant, the UE determines the downlink BWP indicated to be the active one and within the downlink BWP configuration the UE finds a downlink channel configuration (e.g., PDCCH configuration) and, within the downlink channel configuration the UE finds the reference signal list from which the UE selects the reference signal of the target cell to consider active for the downlink channel.

In one example, the L1/L2 inter-cell mobility execution command contains a pointer to a reference signal (e.g., a RS ID, like an SSB index) that refers to a downlink channel configuration in one of the configured reference signals (e.g., configured as QCL source in a TCI state configuration) in the BWP indicated to be activated. If the UE receives in the L1/L2 inter-cell mobility execution command the SSB index=2 for PDCCH (or PDSCH, or both e.g. unified), the downlink beam and/or TCI state to consider active for PDCCH (or PDSCH, or both e.g. unified) is the beam and/or TCI state whose QCL source (e.g. type D) has configured SSB index=2 for PDCCH (or PDSCH, or both e.g. unified) in the downlink BWP considered to be active upon L1/L2 inter-cell mobility execution. This helps the UE interpret the pointer to an reference signal identifier included in the L1/L2 inter-cell mobility execution command, in the sense that the UE knows in which list to look for the reference signal, i.e., the list within the downlink BWP considered to be active, resolving the ambiguity.

The method is further described below as different “solutions”, in different sets of embodiments, disclosing ways in which the UE obtains the indication of a configured BWP(s) of the target candidate cell, such as:
Solution 1) indication of BWP to be activated in the target candidate cell configuration;
Solution 2) indication of BWP to be activated in L1/L2 inter-cell mobility execution command;
Solution 3) pre-determined active BWP;
Solution 4) indication of active BWP optional.

Some embodiments include determining reference signals for measurements to assist L1/L2 inter-cell mobility. For these embodiments, the method further comprises the UE, upon reception of the target candidate cell configuration, performing one or more measurements for reporting (e.g., reference signal receive power (RSRP), reference signal receive quality (RSRQ), signal to interference and noise ratio (SINR)) on one or more reference signal(s), such as SSBs and/or CSI-RS resource, wherein the one or more reference signals are configured in the BWP indicated to be the one to be activated in L1/L2 inter-cell mobility execution. For example, the UE measures and reports SSBs configured as QCL source of TCI states of downlink channel(s) of the downlink BWP indicated as the one to be activated in L1/L2 inter-cell mobility execution.

According to some embodiments, a method at a network node (e.g., candidate distributed unit (DU)) that is capable of L1/L2 inter-cell mobility comprises the candidate DU generating a target candidate cell configuration or parts of the configuration (e.g., a cell group configuration) for a target candidate cell, further providing to the UE an indication of a configured BWP(s) of the target candidate cell, based on which the UE determines the configured BWP to be considered active in the target cell upon reception of a L1/L2 inter-cell mobility execution command.

A first group of embodiments includes a method at a UE capable of L1/L2 inter-cell mobility. The method comprises receiving a L1/L2 inter-cell mobility configuration comprising at least one target candidate cell configuration. The at least one target candidate cell configuration comprises an associated identifier (e.g., reconfiguration ID, configuration ID, cell ID, cell group configuration ID, SpCell configuration ID) for referring to the one target candidate cell configuration and multiple BWP configuration(s) of a type, e.g., multiple downlink BWPs, multiple uplink BWP(s) or both multiple downlink BWPs and uplink BWPs. The method further comprises: obtaining at least one indication of at least one of the configured BWP(s) of the target candidate cell to be activated: receiving a L1/L2 inter-cell mobility execution command including an indication of the one target candidate cell configuration, referring to the identifier associated to the one target candidate cell configuration (e.g., reconfiguration ID, configuration ID, cell ID, cell group configuration ID. SpCell configuration ID); and determining at least one active BWP of the target candidate cell in which the UE is to operate in the target candidate cell based on the indicated target candidate cell configuration, i.e., an active BWP of the cell the UE switches to in L1/L2 inter-cell mobility and the obtained indication of the BWP to be considered active.

In a second group of embodiments, the method further comprises obtaining the indication of the BWP to be considered active in the target candidate cell configuration, as a field, parameter and/or information element.

In a third group of embodiments, the method further comprises obtaining the indication of the BWP to be considered active in the L1/L2 inter-cell mobility execution command the UE receives.

In a fourth group of embodiments, the multiple configured BWP(s) comprise one or more of: one or more downlink BWP(s); one or more uplink BWP(s); and one or more uplink and downlink BWP(s).

In a fifth group of embodiments, the method further comprises determining based on the indication of the BWP to be considered active, one or more of: one or more downlink channel configuration(s) associated to the indicated downlink BWP; one or more uplink channel configuration(s) associated to the indicated uplink BWP; one or more TCI state configuration(s) associated to the indicated downlink and/or uplink BWP; one or more TCI state configuration(s) associated to a downlink channel of the target cell, e.g. PDCCH, PDSCH: one or more uplink spatial relation(s) configuration(s) associated to the indicated uplink BWP; e.g. PUCCH, PUSCH, RACH; and one or more TCI state configuration(s) associated to at least one downlink channel and at least one uplink channel, of the target cell, e.g. PDCCH, PDSCH, PUCCH, PUSCH, RACH, etc.

A sixth group of embodiments is directed to determining one or more reference signals for measurements to assist L1/L2 inter-cell mobility. The method further comprises performing one or more measurements for reporting (e.g., RSRP, RSRQ, SINR) on one or more reference signal(s), such as SSBs and/or CSI-RS resource, wherein the one or more reference signals are configured in the BWP indicated to be the one to be activated in L1/L2 inter-cell mobility execution.

According to some embodiments, a method is performed by a wireless device capable of L1/L2 inter-cell mobility. The method comprises receiving a L1/L2 inter-cell mobility configuration comprising at least one target candidate cell configuration. The at least one target candidate cell configuration comprises one or more BWP configurations. The method further comprises obtaining at least one indication of at least one of the BWP configurations of a target candidate cell to be activated: receiving a L1/L2 inter-cell mobility execution command including an indication of one target candidate cell configuration for a target cell; and determining at least one active BWP of the target cell in which the wireless device is to operate in the target cell based on the indicated target candidate cell configuration.

In particular embodiments, obtaining the at least one indication of the BWP configurations of the target candidate cell to be activated comprises receiving the indication in the at least one target candidate cell configuration, receiving the indication in the received L1/L2 inter-cell mobility execution command, or receiving the indication in a Radio Resource Control (RRC) message.

In particular embodiments, the L1/L2 inter-cell mobility execution command further includes an indication of one or more TCI state configurations.

In particular embodiments, the one or more BWP configurations comprise one or more configurations for one or more downlink BWPs, one or more uplink BWPs, and one or more uplink and downlink BWPs.

In particular embodiments, the target candidate cell configuration is generated by a candidate distributed unit (DU) associated with the target candidate cell configured for L1/L2 inter-cell mobility.

In particular embodiments, the method further comprises, based on the determination of the at least one active BWP, determining one or more of: one or more downlink channel configuration associated with the determined at least one active BWP; one or more uplink channel configuration associated with the determined at least one active BWP; one or more transmission configuration indication (TCI) state configuration associated with the determined at least one active BWP; one or more TCI state configuration associated with a downlink channel of the target cell: one or more TCI state configuration associated with an uplink channel of the target cell; and one or more spatial relation configuration associated with the determined at least one active BWP. Determining one or more TCI state configuration associated with the determined at least one active BWP may further comprise determining a TCI state to be activated based on a TCI state identifier included in the L1/L2 inter-cell mobility execution command.

In particular embodiments, the method further comprises performing one or more measurements on one or more reference signals configured in the determined at least one active BWP.

According to some embodiments, a wireless device comprises processing circuitry operable to perform any of the wireless device methods described above.

According to some embodiments, a method is performed by a network node capable of L1/L2 inter-cell mobility. The method comprises providing a target candidate cell configuration for L1/L2 inter-cell mobility comprising one or more BWP configurations to a wireless device and providing at least one indication of at least one of the one or more BWP configurations to be activated to the wireless device.

In particular embodiments, providing the at least one indication of the BWP configurations to be activated comprises providing the indication in the target candidate cell configuration, providing the indication as part of a L1/L2 inter-cell mobility execution command, or providing the indication in a RRC message.

In particular embodiments, the one or more BWP configurations comprise one or more configurations for one or more downlink BWPs, one or more uplink BWPs, and one or more uplink and downlink BWPs.

In particular embodiments, the network node comprises a candidate distributed unit (DU) associated with a target candidate cell configured for L1/L2 inter-cell mobility.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the wireless device described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, because channel configurations/beam configurations (e.g., TCI state and uplink spatial directions) are defined per BWP, ambiguity exists for the UE in L1/L2 inter-cell mobility regarding which configuration to use, which is resolved by particular embodiments described herein.

In Solution 1, the UE does not need to receive in the L1/L2 inter-cell mobility execution command an indication of the BWP(s) to consider active in the target cell, because that has already been provided in the target candidate cell configuration, which includes at least the following advantages: (a) lower signaling overhead, because the L1/L2 inter-cell mobility execution command has fewer number of bits; and (b) the UE may “pre-load” some of the configuration that is per BWP upon reception of the target candidate cell configuration, or at least before it receives the L1/L2 inter-cell mobility execution command, which may reduce the processing time during execution and, consequently, the interruption time during execution.

On the network side, a candidate distributed Unit (DU), e.g., gNB-DU, responsible for a target candidate cell, upon request from the CU for L1/L2 inter-cell mobility generates a target candidate cell configuration, determines what is the downlink BWP that is to be considered activated in case of L1/L2 inter-cell mobility execution to that cell and indicates that in the target candidate cell configuration, e.g. within the CellGroupConfig, RRCReconfiguration, SpCellConfig.

In Solution 2, the UE may receive in the L1/L2 inter-cell mobility execution command an indication of the BWP(s) to consider active in the target cell, wherein the actual BWP configuration this is indicating has already been provided in the target candidate cell configuration.

One benefit of the solution is that the actual BWP to be activated only needs to be indicated during execution, i.e., the network does not have to determine the active uplink and/or downlink BWP of a target candidate in advance when the UE is just being prepared, but only during the execution. A further benefit is that the network may perform improved load balancing as it may allocate certain UEs for which a L1/L2 candidate cells have been configured in a BWP part and some other for which a different set of L1/L2 mobility cells have been configured in another BWP. A certain BWP may not be suitable. That later indication may require additional indication in the L1/L2 inter-cell mobility execution command.

In Solution 3, the UE does not need to receive in the L1/L2 inter-cell mobility execution command an indication of the BWP(s) to consider active in the target cell, as that has already been provided as a pre-defined configuration in the target candidate cell configuration, which represents some advantages: (a) lower signaling overhead, as the L1/L2 inter-cell mobility execution command will have fewer number of bits; and (b) the UE may “pre-load” some of the configuration which is per BWP upon reception of the target candidate cell configuration, or at least before it receives the L1/L2 inter-cell mobility execution command, which may reduce the processing time during execution and, consequently, the interruption time during execution.

In comparison with solution 1, there is no need to indicate a specific BWP to be activated for downlink and/or uplink because there is only a single BWP configured, which leads to no ambiguity for the UE of which needs to be activated.

In Solution 4, information in the L1/L2 inter-cell mobility execution command takes precedent to the information in the one target candidate cell configuration. A benefit is that the network (e.g., candidate DU), during preparation of L1/L2 inter-cell mobility, may have configured a first BWP to be activated (e.g., downlink BWP with BWP ID=x) but after some time the network determine a new BWP is more appropriate and indicates the new BWP to the serving DU, e.g. during execution or after preparation but before execution, so that at the time of execution the new BWP to be activated is indicated in the L1/L2 inter-cell mobility execution command. In other words, there is no need to reconfigure the UE to update the BWP to be considered activated in the target cell at a later moment because the new BWP to be used is indicated directly upon the switch.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a time frequency diagram illustrating an example of bandwidth adaptation with configuration of three different bandwidth parts;

FIG. 2 illustrates example Radio Resource Control (RRC) configuration for the target candidate configuration:

FIG. 3 illustrates an example of signaling solution 1:

FIG. 4 illustrates another example of signaling solution 1;

FIG. 5 is an example of signaling solution 2:

FIG. 6 is another example of signaling solution 2:

FIG. 7 is a signaling diagram illustrating the signaling of solution 1;

FIG. 8 is a more detailed example of signaling solution 1, according to particular embodiments:

FIG. 9 is another detailed example of signaling solution 1, according to particular embodiments:

FIG. 10 shows an example of a communication system, according to certain embodiments:

FIG. 11 shows a user equipment (UE), according to certain embodiments;

FIG. 12 shows a network node, according to certain embodiments:

FIG. 13 is a block diagram of a host, according to certain embodiments:

FIG. 14 is a block diagram illustrating a virtualization environment in which functions implemented by some embodiments may be virtualized:

FIG. 15 shows a communication diagram of a host communicating via a network node with a UE over a partially wireless connection in accordance with some embodiments:

FIG. 16 is a flowchart illustrating an example method in a wireless device, according to certain embodiments; and

FIG. 17 is a flowchart illustrating an example method in a network node, according to certain embodiments.

### DETAILED DESCRIPTION

As described above, certain challenges currently exist with bandwidth parts (BWPs) and layer one (L1)/layer two (L2) inter-cell mobility. Certain aspects of the disclosure and their embodiments may provide solutions to these or other challenges. For example, in particular embodiments a user equipment (UE) determines which BWP(s) (e.g., downlink BWP and/or uplink BWP) to consider active in the target cell during L1/L2 inter-cell mobility execution.

Particular embodiments are described more fully with reference to the accompanying drawings. Embodiments are provided by way of example to convey the scope of the subject matter to those skilled in the art.

The term “L1/L2 based inter-cell mobility” is used as in the Work Item Description in 3GPP, though the terms L1/L2 mobility, L1-mobility, L1 based mobility, L1/L2-centric inter-cell mobility or L1/L2 inter-cell mobility may also be used interchangeably herein. The basic principle is that the UE receives a lower layer signaling from the network indicating to the UE a change (or switch or activation) of its serving cell (e.g., change of PCell, from a source to a target PCell), wherein a lower layer signaling is a message/signaling of a lower layer protocol, which may be referred as a L1/L2 inter-cell mobility execution command. The change of serving cell (e.g., change of PCell) may also lead to a change in Scell(s) for the same cell group, e.g., if the command triggers the UE to change to another cell group configuration of the same type (e.g., another master cell group (MCG) configuration).

A lower layer protocol refers to a lower layer protocol in the air interface protocol stack compared to Radio Resource Control (RRC) protocol, e.g., medium access control (MAC) is considered a lower layer protocol because it is below RRC in the air interface protocol stack, and a lower layer signaling/message may correspond to a MAC control element (CE). Another example of lower layer protocol is the Layer 1 (or Physical Layer, L1), and a lower layer signaling/message may correspond to downlink control information (DCI). Signaling information in a protocol layer lower than RRC reduces the processing time and, consequently, reduces the interruption time during mobility. In addition, it may also increase the mobility robustness as the network may respond faster to changes in the channel conditions.

Another relevant aspect in L1/L2 inter-cell mobility is that in a multi-beam scenario, a cell can be associated to multiple synchronization signal blocks (SSBs), and during a half-frame, different SSBs may be transmitted in different spatial directions (i.e., using different beams, spanning the coverage area of a cell). Similar reasoning may be applicable to channel state information reference signal (CSI-RS) resources, which may also be transmitted in different spatial directions. Thus, in L1/L2 inter-cell mobility, the reception of lower layer signaling indicates the UE to change from one beam in the serving cell, to another beam in a neighbor cell (which is a configured candidate cell), and thus changing serving cell.

The term target candidate configuration refers to the configuration of a “L1/L2 inter-cell mobility candidate cell”, which is a cell the UE is configured with when configured with L1/L2 inter-cell mobility. In other words, the target cell is a cell the UE can move to in a L1/L2 inter-cell mobility procedure upon reception of lower layer signaling. These cells may also be referred to as candidate cell(s), candidates, mobility candidates, non-serving cells, additional cells, target candidate cell, target candidate, etc. This is a cell the UE performs measurements on (e.g., channel state information (CSI) measurements) so that the UE reports these measurements and the network may make an educated decision on which beam (e.g., transmission configuration indicator (TCI) state) and/or cell the UE is to be switched to. A L1/L2 inter-cell mobility candidate cell may be a candidate to be a target PCell or PSCell, or an SCell of a cell group (e.g., MCG SCell).

The actual target candidate configuration and its content and/or structure of the IE and/or embedded message may be referred to as an RRC model for the candidate configuration, or simply RRC model. A target candidate configuration comprises the configuration that the UE uses to operate accordingly when the UE performs (executes) L1/L2 inter-cell mobility execution to the target candidate cell upon reception of the lower layer signaling indicating a L1/L2 based inter-cell mobility to the target candidate cell (which becomes the target cell and the current (new) PCell, or an SCell in a serving frequency). The UE may be configured with multiple target candidate cells, so a candidate DU generates and sends to the CU multiple configuration(s). The target candidate configuration comprises at least parameters of a serving cell (or multiple serving cells) comprising one or more of the groups of parameters within the IE SpCellConfig (or the IE SCellConfig, for a secondary cell).

Some examples of how the signaling may be implemented in RRC for the target candidate configuration are described as RRC models for L1/L2 based inter-cell mobility:

a) RRC Reconfiguration per candidate cell. In this case the UE receives multiple (a list of) RRC messages (i.e., RRCReconfiguration message) within a single RRCReconfiguration message. Each RRCReconfiguration message identifies a target candidate configuration that is stored by the UE and is applied/used/activated when receiving the lower layer signaling for L1/L2 inter-cell mobility. This model enables the full flexibility, as in L3 reconfigurations, for the target node to modify/release/keep any parameter/field in the RRCReconfiguration message such as measurement configuration, bearers, etc.

b) CellGroupConfig per candidate cell. With this model the UE receives within an RRCReconfiguration a list of CellGroupConfig IEs and each one of them identify a target candidate configuration. Each CellGroupConfig IE is stored at the UE and is applied/used/activated when receiving the lower layer signaling for L1/L2 inter-cell mobility. This model enables the target node to modify/release/keep any parameter/field that is part of a CellGroupConfig IE while the rest of the RRCReconfiguration message (that is where the CellGroupConfig IE is received by the UE) remain unchanged. This means that e.g., measurement configuration, bearers, and security remain the same and are not changed by the target node.

c), d), and e) “K” SpCellConfig or “K” ServingCellConfigCommon, or both per cell. With this model the UE receives either “K” SpCellConfig per cell (option c), “K” ServingCellConfigCommon per cell (option e), or “K” SpCellConfig and “K” ServingCellConfigCommon per cell (option d) as a target candidate configuration. This solution provides only minimum flexibility for the target node because only cell-specific parameters (e.g., bandwidth parts, downlink, and uplink configurations) can be modified/released/kept.

f) “K” PCI in the same PCell. With this model multiple physical cell identifiers (PCIs) are configured for the same TCI state configuration where each PCI identifies a target candidate configuration. This approach provides no flexibility because all the parameters/fields used for configuring a target candidate configuration are fixed and only a change of PCI, scrambling identifier, and cell radio network temporary identifier (C-RNTI) is possible for the target node.

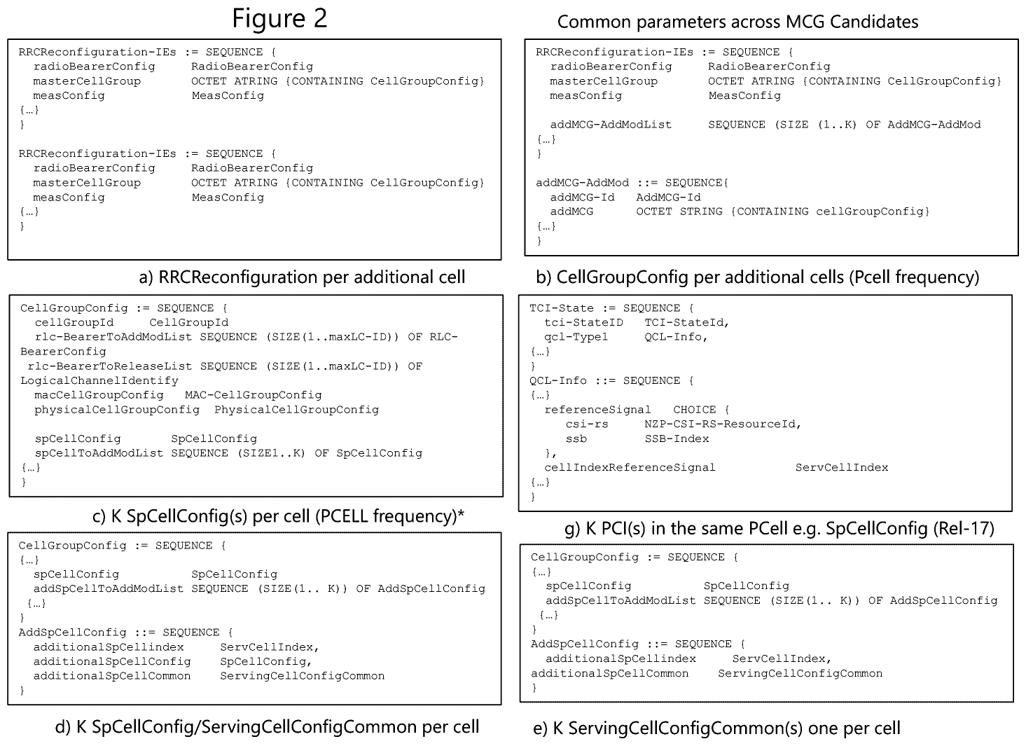

FIG. 2 illustrates example RRC configuration for the target candidate configuration. The illustrated examples include examples of a-f described above.

The L1/L2 inter-cell mobility configuration may correspond to a field and/or information element defined in RRC protocol (e.g., in ASN.1 format) comprising one or more target candidate cell configuration(s). The L1/L2 inter-cell mobility configuration may comprise multiple target candidate cell configuration(s) when the UE is configured with multiple target candidate cell(s) for L1/L2 inter-cell mobility. That L1/L2 inter-cell mobility configuration may be included in an RRCReconfiguration message (as defined in 3GPP TS 38.331), or an RRC Resume message the UE receives, e.g., during a state transition to RRC_CONNECTED.

The L1/L2 inter-cell mobility configuration may be generated by a central unit (CU), e.g. gNB-CU, and include information generated and transmitted from a candidate distributed unit (DU), such as the target candidate cell configuration and/or a measurement configuration indicating the UE to perform measurements on reference signals, e.g. SSBs and/or CSI-RS resources, of a target candidate cell, for reporting to the network to assist L1/L2 inter-cell mobility execution decisions.

The target candidate cell configuration comprises the configuration based on which the UE operates in the target candidate cell if that cell is indicated as a target cell in the L1/L2 inter-cell mobility execution command.

Signaling solution 1 includes an indication of the active BWP in the target candidate cell configuration. In a set of embodiments, the UE receives a L1/L2 inter-cell mobility configuration, comprising at least one target candidate cell configuration (e.g., an RRCReconfiguration, a CellGroupConfig, or an SpCellConfig per target candidate), wherein the one target candidate cell configuration includes multiple BWP configuration(s) (e.g., a list of downlink BWPs and a list of uplink BWPs for the target candidate cell) and at least one indication of at least one of the configured BWP(s) of the target candidate cell to be activated (not upon reception of the message, but upon switchover). The UE receives with the one target candidate cell configuration an associated identifier (e.g., reconfiguration ID, configuration ID, cell ID, cell group configuration ID, SpCell configuration ID), for referring to the one target candidate cell configuration, e.g., in a future message.

Some embodiments may include one indication for the downlink BWP that is to be considered active upon L1/L2 inter-cell mobility execution, and one indication for the uplink BWP that is to be considered active upon L1/L2 inter-cell mobility execution.

Further, the at least one indication of at least one of the configured BWP(s) of the target candidate cell to be activated may be specific to one target candidate cell configuration or it may be common for all the target candidate cells configured by a specific network node (i.e., a DU). This means that if one DU configured multiple target cell configurations at the UE, the DU may decide to include a common indication for the BWP to be activated upon the reception of the L1/L2 inter-cell mobility execution command.

In some embodiments, the UE further receives a L1/L2 inter-cell mobility execution command including an indication of the one target candidate cell configuration, referring to the identifier associated to the one target candidate cell configuration (e.g. reconfiguration ID, configuration ID, cell ID, cell group configuration ID, SpCell configuration ID). This means the UE receives another message, this time as a lower layer protocol message, like a MAC CE or DCI for executing L1/L2 inter-cell mobility. Based on the indicated target candidate cell configuration, the UE determines an active BWP of the target candidate cell in which the UE is to operate, i.e., an active BWP of the cell the UE switches to in L1/L2 inter-cell mobility.

In one embodiment, the UE considers the bandwidth part indicated in the indication of at least one of the configured BWP(s) of the target candidate cell to be activated (not upon reception of the message) to be the active uplink bandwidth part.

For example, the indication of at least one of the configured BWP(s) of the target candidate cell to be activated (not upon reception of the message) may correspond to the field “firstActiveUplinkBWP-Id” within the SpCell configuration (e.g., SpCellConfig) within the indicated one target candidate cell configuration, so that the UE considers the bandwidth part indicated in firstActiveUplinkBWP-Id, if configured, to be the active uplink bandwidth part. The field firstActiveUplinkBWP-Id points to one of the configured BWP in the uplinkBWP-ToAddModList, which is a SEQUENCE (SIZE (1 . . . maxNrofBWPs)) OF BWP-Uplink, also part of the SpCell configuration (in the IE ServingCellConfig).

For example, the field “firstActiveUplinkBWP-Id” within the SpCell configuration is set to “2”, and the UE is configured with a list of four uplink BWP(s), as follows uplinkBWP-ToAddModList set to [BWP-Uplink with bwp-Id=0, BWP-Uplink with bwp-Id=1, BWP-Uplink with bwp-Id=2, BWP-Uplink with bwp-Id=3]. Then, the firstActiveUplinkBWP-Id set to 2 means that the UE considers the configured BWP-Uplink with bwp-Id=2 as active upon L1/L2 inter-cell mobility execution. Below is an ASN.1 structure for the BWP-Uplink:

| BWP-Uplink ::= | SEQUENCE { |
|---|---|
| bwp-Id | BWP-Id, |
| bwp-Common | BWP-UplinkCommon |
| OPTIONAL, -- Cond SetupOtherBWP | |
| bwp-Dedicated | BWP-UplinkDedicated |

OPTIONAL, -- Cond SetupOtherBWP
...
}

In one embodiment, the UE considers the bandwidth part indicated in the indication of at least one of the configured BWP(s) of the target candidate cell to be activated (not upon reception of the message) to be the active downlink bandwidth part.

For example, the indication of at least one of the configured BWP(s) of the target candidate cell to be activated (not upon reception of the message) may correspond to the field “firstActiveDownlinkBWP-Id” within the SpCell configuration (e.g., SpCellConfig) within the indicated one target candidate cell configuration, so that the UE considers the bandwidth part indicated in firstActiveDownlinkBWP-Id, if configured, to be the active downlink bandwidth part. The field firstActiveDownlinkBWP-Id points to one of the configured BWP in the downlinkBWP-ToAddModList, which is a SEQUENCE (SIZE (1 . . . maxNrofBWPs)) OF BWP-Downlink, also part of the SpCell configuration (in the IE ServingCellConfig).

For example, the field “firstActiveDownlinkBWP-Id” within the SpCell configuration is set to “2”, and the UE is configured with a list of four downlink BWP(s) as follows downlinkBWP-ToAddModList u set to [BWP-Downlink with bwp-Id=0, BWP-Downlink with bwp-Id=1, BWP-Downlink with bwp-Id=2, BWP-Downlink with bwp-Id=3]. Then, the firstActiveDownlinkBWP-Id set to 2 means that the UE considers the configured BWP-Downlink with bwp-Id=2 as active upon L1/L2 inter-cell mobility execution. Below is an ASN.1 structure for the BWP-Downlink:

| | |
|---|---|
| bwp-Dedicated | BWP-DownlinkDedicated |

OPTIONAL, -- Cond SetupOtherBWP
...
}

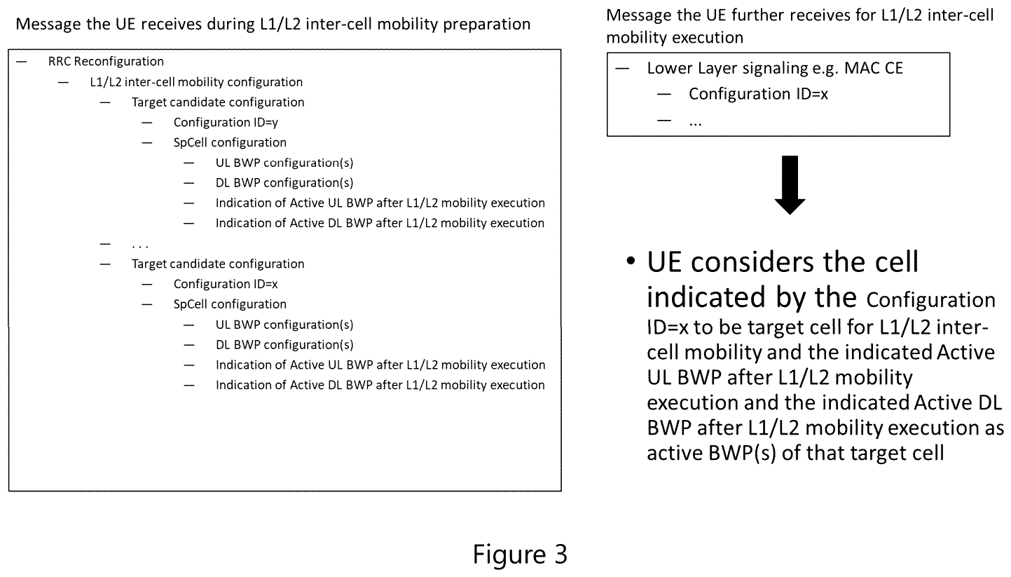

FIG. 3 illustrates an example of signaling solution 1, described above. The illustrated example illustrates the message a UE receives during L1/L2 inter-cell mobility preparation on the left and the message the UE further receives for L1/L2 inter-cell mobility execution on the right.

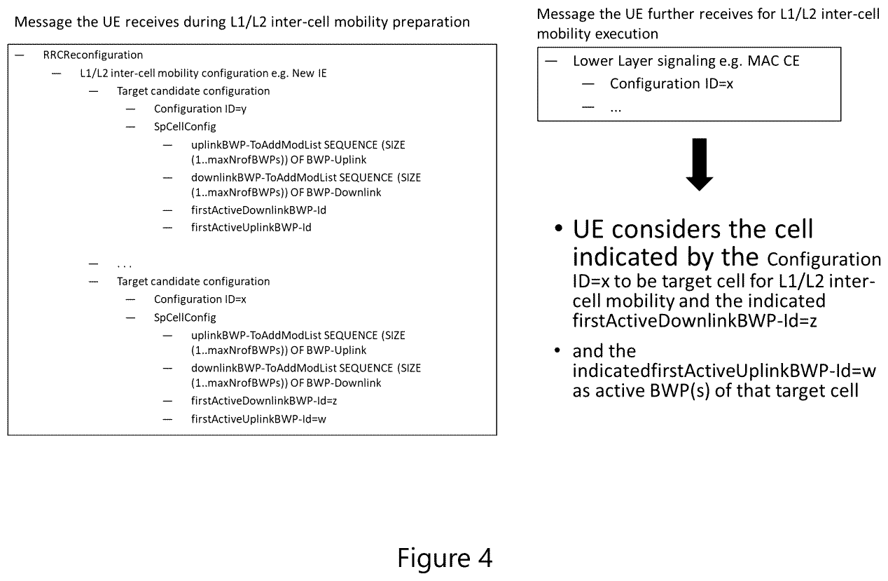

FIG. 4 illustrates another example of signaling solution 1, described above. The illustrated example illustrates the message a UE receives during L1/L2 inter-cell mobility preparation on the left and the message the UE further receives for L1/L2 inter-cell mobility execution on the right.

Signaling solution 2 includes an indication of the active BWP in the L1/L2 inter-cell mobility execution command. In a set of embodiments, the UE receives a L1/L2 inter-cell mobility configuration, comprising at least one target candidate cell configuration (e.g., an RRCReconfiguration, a CellGroupConfig, or an SpCellConfig per target candidate), wherein the one target candidate cell configuration includes multiple BWP configuration(s) (e.g., a list of downlink BWPs and a list of uplink BWPs for the target candidate cell). The UE receives with the one target candidate cell configuration an associated identifier (e.g., reconfiguration ID, configuration ID, cell ID, cell group configuration ID, SpCell configuration ID) for referring to the one target candidate cell configuration, e.g., for use with a future message.

The UE further receives a L1/L2 inter-cell mobility execution command including an indication of the one target candidate cell configuration referring to the identifier associated to the one target candidate cell configuration (e.g., reconfiguration ID, configuration ID, cell ID, cell group configuration ID. SpCell configuration ID) and at least one indication of at least one of the configured BWP(s) of the target candidate cell to be activated upon L1/L2 inter-cell mobility execution. Based on the indicated target candidate cell configuration and the indication of at least one of the configured BWP(s) of the target candidate cell to be activated upon L1/L2 inter-cell mobility execution, the UE determines an active BWP of the target candidate cell in which the UE is to operate, i.e., an active BWP of the cell the UE switches to in L1/L2 inter-cell mobility.

In one embodiment, the UE considers the bandwidth part indicated in the indication of at least one of the configured BWP(s) of the target candidate cell to be activated (not upon reception of the message) to be the active uplink bandwidth part.

For example, the indication of at least one of the configured BWP(s) of the target candidate cell to be activated (not upon reception of the message) may correspond to the field “firstActiveUplinkBWP-Id” in the L1/L2 inter-cell mobility execution command (e.g., a field in a MAC control element) pointing to an uplink BWP configuration within the SpCell configuration (e.g., SpCellConfig) within the indicated one target candidate cell configuration, so that the UE considers the bandwidth part indicated in firstActiveUplinkBWP-Id, if configured, to be the active uplink bandwidth part. The field firstActiveUplinkBWP-Id of the L1/L2 inter-cell mobility execution command points to one of the configured BWP(s) in the uplinkBWP-ToAddModList, which is a SEQUENCE (SIZE (1 . . . maxNrofBWPs)) OF BWP-Uplink, also part of the SpCell configuration (in the IE ServingCellConfig).

For example, the field “firstActiveUplinkBWP-Id” in the L1/L2 inter-cell mobility execution command is set to “2”, and the UE is configured within the SpCell configuration with a list of four uplink BWP(s), as follows uplinkBWP-ToAddModList set to [BWP-Uplink with bwp-Id=0, BWP-Uplink with bwp-Id=1, BWP-Uplink with bwp-Id=2. BWP-Uplink with bwp-Id=3]. Then, the firstActiveUplinkBWP-Id set to 2 means that the UE considers the configured BWP-Uplink with bwp-Id=2 as active upon L1/L2 inter-cell mobility execution.

In one embodiment, the UE considers the bandwidth part indicated in the indication of at least one of the configured BWP(s) of the target candidate cell to be activated (not upon reception of the message) to be the active downlink bandwidth part.

For example, the indication of at least one of the configured BWP(s) of the target candidate cell to be activated (not upon reception of the message) may correspond to the field “firstActiveDownlinkBWP-Id” in the L1/L2 inter-cell mobility execution command (e.g., a field in a MAC control element) pointing to a downlink BWP configuration within the SpCell configuration (e.g., SpCellConfig) within the indicated one target candidate cell configuration, so that the UE considers the bandwidth part indicated in firstActiveDownlinkBWP-Id, if configured, to be the active downlink bandwidth part. The field firstActiveDownlinkBWP-Id points to one of the configured BWP in the downlinkBWP-ToAddModList, which is a SEQUENCE (SIZE (1 . . . maxNrofBWPs)) OF BWP-Downlink, also part of the SpCell configuration (in the IE ServingCellConfig).

For example, the field “firstActiveDownlinkBWP-Id” within the L1/L2 inter-cell mobility execution command is set to “2”, and the UE is configured in the SpCell configuration with a list of 4 DL BWP(s), as follows downlinkBWP-ToAddModList set to [BWP-Downlink with bwp-Id=0, BWP-Downlink with bwp-Id=1, BWP-Downlink with bwp-Id=2, BWP-Downlink with bwp-Id=3]. Then, the firstActiveDownlinkBWP-Id set to 2 in the L1/L2 inter-cell mobility execution command means that the UE considers the configured BWP-Downlink with bwp-Id=2 as active upon L1/L2 inter-cell mobility execution.

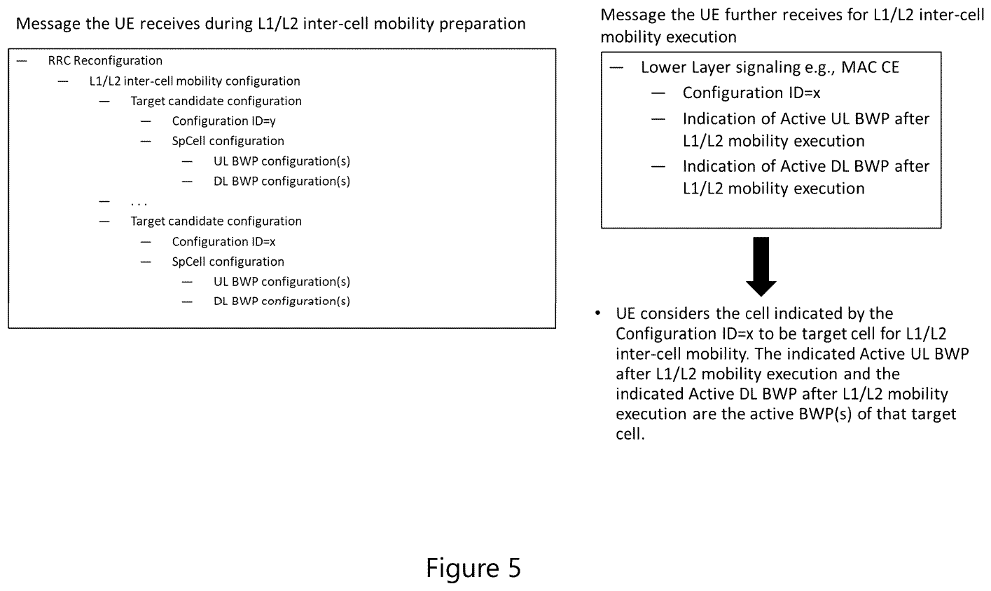

FIG. 5 is an example of signaling solution 2, described above. The illustrated example illustrates the message a UE receives during L1/L2 inter-cell mobility preparation on the left and the message the UE further receives for L1/L2 inter-cell mobility execution on the right.

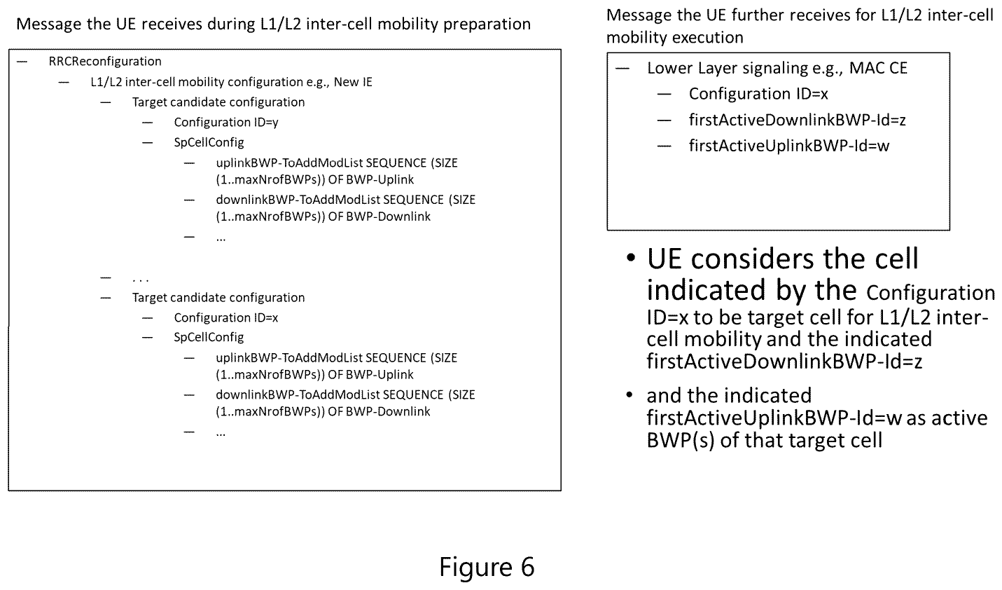

FIG. 6 is another example of signaling solution 2, described above. The illustrated example illustrates the message a UE receives during L1/L2 inter-cell mobility preparation on the left and the message the UE further receives for L1/L2 inter-cell mobility execution on the right.

In the current version of the RRCReconfiguration message, the field firstActiveDownlinkBWP-Id is mandatory in a reconfiguration with synchronization procedure. However, a L3 handover, triggered by the reception of an RRCReconfiguration message including the IE Reconfiguration WithSync is not the same procedure as the L1/L2 inter-cell mobility, though there may be some similarities.

According to a set of embodiments, the target candidate configuration, or more specifically its SpCell configuration, may have the field “firstActive DownlinkBWP-Id” defined in ASN.1 as an optional field when it is for a target candidate for L1/L2 inter-cell mobility.

According to a set of embodiments, the target candidate configuration, or more specifically its SpCell configuration, may have the field “firstActive DownlinkBWP-Id” defined in ASN.1 as an optional field if it is for a target candidate for L1/L2 inter-cell mobility, which is always included, but according to the solution 2, the field is ignored or overruled by an equivalent field in the L1/L2 inter-cell mobility execution command.

Signaling solution 3 includes a single BWP. In a set of embodiments, the UE receives a L1/L2 inter-cell mobility configuration, comprising at least one target candidate cell configuration (e.g., an RRCReconfiguration, \ a CellGroupConfig, or an SpCellConfig per target candidate), wherein the one target candidate cell configuration includes a single BWP configuration per direction (e.g., a single BWP configuration for downlink and a single BWP configuration for uplink for the target candidate cell). The UE receives with the one target candidate cell configuration an associated identifier (e.g., reconfiguration ID, configuration ID, cell ID, cell group configuration ID, SpCell configuration ID) for referring to the one target candidate cell configuration, e.g., for use with a future message. The single BWP configuration may be the initial BWP configuration for the downlink, and the initial BWP configuration for the uplink.

In some embodiments, the UE further receives a L1/L2 inter-cell mobility execution command including an indication of the one target candidate cell configuration, referring to the identifier associated to the one target candidate cell configuration (e.g., reconfiguration ID, configuration ID, cell ID, cell group configuration ID, SpCell configuration ID). Based on the indicated target candidate cell configuration, the UE determines an active BWP of the target candidate cell in which the UE is to operate, i.e., an active BWP of the cell the UE switches to in L1/L2 inter-cell mobility.

In one embodiment, the UE considers the single uplink bandwidth part to be the active uplink bandwidth part. In one embodiment, the UE considers consider the single downlink bandwidth part to be the active downlink bandwidth part.

Signaling solution 4 includes an optional indication of an active BWP. In a set of embodiments, with some similarities to solution 1, the UE receives a L1/L2 inter-cell mobility configuration comprising at least one target candidate cell configuration (e.g., an RRCReconfiguration, a CellGroupConfig, or an SpCellConfig per target candidate), wherein the one target candidate cell configuration includes multiple BWP configuration(s) (e.g., a list of downlink BWPs and a list of uplink BWPs for the target candidate cell).

The UE receives with the one target candidate cell configuration an associated identifier (e.g., reconfiguration ID, configuration ID, cell ID, cell group configuration ID. SpCell configuration ID) for referring to the one target candidate cell configuration e.g. at a later message.

The UE further receiving a L1/L2 inter-cell mobility execution command including at least an indication of the one target candidate cell configuration, referring to the identifier associated to the one target candidate cell configuration (e.g., reconfiguration ID, configuration ID, cell ID, cell group configuration ID, SpCell configuration ID).

Then, the UE determines the at least one BWP to be active (e.g., downlink BWP, uplink BWP) in the target cell selectively according to one of the rules: (a) when the one target candidate cell configuration includes at least one indication of at least one of the configured BWP(s) of the target candidate cell to be activated (like in Solution 1) and when the L1/L2 inter-cell mobility execution command does not include an indication of at least one of the configured BWP(s) of the target candidate cell to be activated, then the UE considers the indicated BWP in the one target candidate cell configuration as the active BWP upon L1/L2 inter-cell mobility execution: (b) when the one target candidate cell configuration includes at least one indication of at least one of the configured BWP(s) of the target candidate cell to be activated (like in Solution 1) and when the L1/L2 inter-cell mobility execution command also includes an indication of at least one of the configured BWP(s) of the target candidate cell to be activated, then the UE considers the indicated BWP in the L1/L2 inter-cell mobility execution command as the active BWP upon L1/L2 inter-cell mobility execution: (c) when the one target candidate cell configuration does not include at least one indication of at least one of the configured BWP(s) of the target candidate cell to be activated (like in Solution 1) and when the L1/L2 inter-cell mobility execution command includes an indication of at least one of the configured BWP(s) of the target candidate cell to be activated, then the UE considers the indicated BWP in the L1/L2 inter-cell mobility execution command as the active BWP upon L1/L2 inter-cell mobility execution; and (d) when the one target candidate cell configuration does not include at least one indication of at least one of the configured BWP(s) of the target candidate cell to be activated (like in Solution 1) and when the L1/L2 inter-cell mobility execution command does not include an indication of at least one of the configured BWP(s) of the target candidate cell to be activated, then the UE considers the initial BWP in the one target candidate cell configuration as the active BWP upon L1/L2 inter-cell mobility execution.

The UE may determine the at least one BWP to be activated for uplink and downlink independently, and thus according to one of the methods described above. For example, the uplink BWP may be determined according to method a) while the downlink BWP may be determined according to method c).

Some embodiments include determination of TCI state ID in the in the L1/L2 inter-cell mobility execution command. A UE upon determining the uplink BWP ID based on solution 1, 2, 3 or 4 described above, based on the indicated uplink TCI state ID in the L1/L2 inter-cell mobility execution command, determines the active uplink TCI state ID among the list of configured uplink TCI states to be used for the first (and further subsequent) transmission to the gNB. In one example, if an uplink BWP is configured with four uplink TCI states, UL TCI 0, 1, 2 and 3, UE selects UL TCI 2, if the L1/L2 inter-cell mobility execution command indicates UL TCI 2 as the active uplink TCI state.

In some embodiments, selection of first active uplink TCI state may be based on the SSB ID indicated/selected for a contention free random access channel (RACH) procedure or contention based RACH procedure.

In some embodiments, a UE upon determining the uplink BWP ID based on solution 1, 2, 3 or 4, based on the indicated uplink spatial relation ID in the L1/L2 inter-cell mobility execution command, determines the active uplink spatial relation info ID among the list of configured uplink spatial relation info IDs to be used for the first (and further subsequent) transmission to the gNB. In one example, if an uplink BWP is configured with four uplink spatial relation info IDs, uplink spatial relation info ID 0, 1, 2 and 3, the UE selects uplink spatial relation info ID 2, if the L1/L2 inter-cell mobility execution command indicates uplink spatial relation info ID 2 as the active uplink spatial relation info ID.

In some embodiments, selection of first active uplink spatial relation info ID may be based on the SSB ID indicated/selected for a contention free RACH procedure or contention based RACH procedure.

A UE upon determining the downlink BWP ID based on solution 1, 2, 3 or 4, based on the indicated downlink TCI state ID in the L1/L2 inter-cell mobility execution command, determines the active downlink TCI state ID among the list of configured downlink TCI states to be used for the first (and further subsequent) reception from the gNB. In one example, if a downlink BWP is configured with four downlink TCI states, DL TCI 0, 1, 2 and 3, the UE selects DL TCI 2, if the L1/L2 inter-cell mobility execution command indicates DL TCI 2 as the active DL TCI state.

In some embodiments, selection of first active downlink TCI state may be based on the SSB ID indicated or selected for a contention free RACH procedure or contention based RACH procedure.

A UE upon determining the downlink BWP ID based on solution 1, 2, 3 or 4, based on the indicated downlink TCI state ID for PDCCH and/or downlink TCI state ID for PDSCH in the L1/L2 inter-cell mobility execution command, determines the active downlink TCI state ID for PDCCH and active TCI state ID for PDSCH among the list of configured TCI states for PDCCH channel and configured TCI states for PDSCH channel respectively. In one example, if a downlink BWP is configured with four downlink TCI state ID for PDCCH and with respective IDs 0, 1, 2 and 3, UE selects downlink TCI state ID 2 for PDCCH channel, if the L1/L2 inter-cell mobility execution command indicates downlink TCI state ID 2 as the active downlinks TCI state ID for PDCCH. In one example, if a DL BWP is configured with four downlink TCI state ID for PDSCH and with respective IDs 0, 1, 2 and 3, UE selects DL TCI state ID 2 for PDSCH channel, if the L1/L2 inter-cell mobility execution command indicates downlink TCI state ID 2 as the active downlink TCI state ID for PDSCH. In some scenarios, if the L1/L2 inter-cell mobility execution command does not indicate a downlink TCI state ID for the PDSCH channel, the UE uses the TCI state ID indicated for PDCCH as the active TCI state ID for the PDSCH channel also.

In some embodiments, selection of first active downlink TCI state ID for PDCCH and downlink TCI state ID for PDSCH may be based on the SSB ID indicated/selected for a contention free RACH procedure or contention-based RACH procedure.

Some embodiments include UE actions upon determining the uplink BWP of target cell to be considered active. Upon determining which uplink BWP is considered active, according to at least one of the solutions disclosed, the UE performs one or more of the actions according to one or more of the following.

Some embodiments include uplink channel configuration for accessing the target candidate cell. In a set of embodiments, the UE receives the L1/L2 inter-cell mobility execution command and selects and uses an uplink channel configuration, which may be a PUCCH configuration, a PUSCH configuration, and/or a RACH configuration, to access the target candidate cell (e.g., to transmit a scheduling request to obtain a scheduling grant to transmit an uplink message to the target cell, to indicate the execution of L1/L2 inter-cell mobility) associated to the uplink BWP indicated to be activated. The received target candidate cell configuration (e.g., a CellGroupConfig with an SpCell configuration) contains an SpCell configuration that has a list of uplink BWP(s) configuration(s), and each uplink BWP configuration (e.g., in IE BWP-Uplink) has at least one uplink channel configuration (e.g., RACH-ConfigCommon, included in a series of nested IEs, such as BWP-UplinkCommon and BWP-Uplink). The UE obtains the indication of the uplink BWP to be considered active, e.g. uplink BWP whose bwp ID=w; and the uplink channel configuration within the BWP configuration, whose bwp ID=w, to access the target candidate cell.

In one embodiment, the uplink channel configuration to be used to access the target candidate cell is a PUCCH configuration (e.g., including at least the parameters in the IE PUCCH-Config as defined in 3GPP TS 38.331). The PUCCH configuration may be used to indicate to the UE how to transmit in the uplink of the target candidate cell a scheduling request (SR) for transmitting a further UL message, e.g. to indicate the execution of L1/L2 inter-cell mobility. The IE PUCCH-Config is used to configure UE specific PUCCH parameters (per BWP) and contains, for example, the following parameters/fields/IEs:
resourceSetToAddModList: Lists for adding and releasing PUCCH resource sets (see 3GPP TS 38.213, clause 9.2).
resourceToAddModList: Lists for adding PUCCH resources applicable for the uplink BWP (indicated to be the active BWP in the target candidate cell) in which the PUCCH-Config is defined. The resources defined herein are referred to from other parts of the configuration to determine which resource the UE shall use for which report.
format1, format2, format3, format4: Parameters that are common for all PUCCH resources of respectively format 1 (e.g., initial cyclic ship, number of symbols, starting symbol index), format 2, format 3 and format 4.
schedulingRequestResourceToAddModList: determines physical layer resources on PUCCH where the UE may send the dedicated scheduling request (D-SR) (see 3GPP TS 38.213, clause 9.2.4).
dl-DataToUL-ACK: List of timing for given PDSCH to the downlink ACK (see 3GPP TS 38.213, clause 9.1.2).
spatialRelationInfoToAddModList: Configuration of the spatial relation between a reference signal and PUCCH. The reference signal may be SSB/CSI-RS/SRS. If the list has more than one element, MAC-CE selects a single element (see 3GPP TS 38.321, clause 5.18.8 and TS 38.213, clause 9.2.2).
pucch-PowerControl: UE-specific parameters for the power control of PUCCH.

In one embodiment, the uplink channel configuration to be used to access the target candidate cell is the PUSCH configuration, including at least the parameters in the IE PUSCH-Config, that may be used to transmit in the uplink of the target candidate cell a scheduling request (SR) and/or to configure an uplink grant for transmitting a further uplink message, e.g. to indicate the execution of L1/L2 inter-cell mobility.

In one embodiment the uplink channel configuration to be used to access the target candidate cell is a RACH configuration, including at least the parameters in the IE RACH-Config and/or RACH-ConfigCommon, that may be used by the UE to select a preamble for transmitting to the target cell, for receiving a Random access Response (RAR) message, for determining the time slots/frequency resource(s) for random access transmissions, threshold for SSB and/or CSI-RS selection, during the execution of L1/L2 inter-cell mobility if Random access if needed.

Some embodiments include uplink spatial relation or uplink TCI state configuration for accessing the target candidate cell. In a set of embodiments, a UE receives the L1/L2 inter-cell mobility execution command and selects and uses at least one uplink spatial relation or spatial direction (of an uplink channel) or uplink TCI state to be considered activated (e.g., in the IE PUCCH-SpatialRelationInfo), wherein the selected uplink spatial relation, spatial direction, or uplink TCI state being associated to the uplink BWP that is indicated to be activated. The UE uses the indicated uplink spatial direction to transmit uplink information to the target candidate cell, as the selected uplink spatial direction indicates a spatial direction in which the UE transmits information from the target candidate cell. In one variant, the UE determines the uplink BWP indicated to be the active one and within the uplink BWP configuration the UE finds an uplink channel configuration (e.g., PUCCH, PUSCH and/or RACH configuration) and, within the uplink channel configuration the UE finds the list of uplink spatial relation states from which the UE finds the indicated uplink spatial relation of the target cell to consider active for the uplink channel.

In one example, the L1/L2 inter-cell mobility execution command contains a pointer to an uplink spatial relation (e.g., an uplink channel spatial relation ID, such as pucch-SpatialRelationInfoId) that refers to an uplink channel configuration in one of the configured uplink spatial relations in the BWP indicated to be activated. If the UE receives in the L1/L2 inter-cell mobility execution command the uplink spatial relation ID=2 for PUCCH, the spatial relation to consider active for PUCCH is the spatial relation with spatial relation ID=2 configured for PUCCH in the uplink BWP considered to be active upon L1/L2 inter-cell mobility execution. This helps the UE interpret the pointer to an uplink spatial relation included in the L1/L2 inter-cell mobility execution command, in the sense that the UE knows in which list to look for the uplink spatial relation. i.e., the list within the uplink BWP considered to be considered active, resolving the ambiguity.

In one example, using signaling solution 1 for the BWP indication, the UE has received in the target candidate configuration the indication of the uplink BWP to be activated, such as the field “firstActiveUplinkBWP-Id”, which is set to a value associated to a BWP ID of one of the configured uplink BWPs of the target candidate cell. The indication, e.g. “firstActiveUplinkBWP-Id” in the target candidate cell configuration indicated in the L1/L2 inter-cell mobility execution command is set to ‘w’, so the uplink BWP configuration in which the UE finds the relevant TCI states for L1/L2 inter-cell mobility execution is the uplink BWP configuration of the target candidate cell in which the BWP Id is “w”. The indicated uplink BWP has a set of TCI states, e.g., TCI state 1, TCI state 2, TCI state 3, e.g., for the PUCCH. If the L1/L2 inter-cell mobility execution command further indicates the TCI state ID=2, the UE knows the TCI state to be activated is the TCI state whose ID=2 within the uplink BWP indicated to be activated (regardless if other downlink BWPs also have a TCI state whose TCI state ID=2). The UE determines how it shall transmit information (e.g., scheduling requests) in the uplink in the target candidate cell upon L1/L2 inter-cell mobility execution using the indication of the TCI state and uplink BWP to be considered active.

In another example, uplink TCI state ID is determined based on the SSB ID associated with the contention free random access preamble configured or indicated in the L1/L2 inter-cell mobility execution command. For example, if the RACH is performed based on the SSB ID 0), then the TCI state which is QCLed with the SSB ID 0 is assumed as the uplink TCI state for the first transmission (and also for the subsequent transmission until the TCI state ID is updated) in the uplink.

In some embodiments, uplink spatial relation info ID is determined based on the SSB ID associated with the contention free random access preamble configured or indicated in the L1/L2 inter-cell mobility execution command. For example, if the RACH is performed based on the SSB ID 0), then the uplink spatial relation info ID which is QCLed with the SSB ID 0 is assumed as the uplink spatial relation info ID for the first transmission (and also for the subsequent transmission until the uplink spatial relation info ID is updated) in the uplink. In another example, uplink TCI state ID may be determined (e.g., indicated in L1/L2 inter-cell mobility execution command to determine the TCI state ID based on the SSB ID used to determine the RACH preamble) based on the SSB ID associated with the contention based random access preamble transmitted. For example, if the RACH is performed based on the SSB ID 0), then the TCI state that is QCLed with the SSB ID 0 is assumed as the uplink TCI state for the first transmission (and also for the subsequent transmission until the TCI state ID is updated) in the uplink.

In some embodiments, uplink spatial relation info ID is determined based on the SSB ID associated with the contention based random access preamble chosen/transmitted to gNB (e.g., indicated in L1/L2 inter-cell mobility execution command to determine the TCI state ID based on the SSB ID used to determine the RACH preamble). For example, if the RACH is performed based on the SSB ID 0), then the uplink spatial relation info ID that is QCLed with the SSB ID 0 is assumed as the UL spatial relation info ID for the first transmission (and also for the subsequent transmission until the uplink spatial relation info ID is updated) in the uplink.

In some embodiments, the uplink TCI indication in the L1/L2 inter-cell mobility execution command may contain only one TCI state ID for all the uplink channels (PUCCH, PUSCH) (for example, if the TCI state is configured as unified TCI state ID). In some embodiments, uplink spatial relation information indication in the L1/L2 inter-cell mobility execution command may contain different uplink spatial relation info IDs for the PUCCH channel and different uplink spatial relation info ID for the PUSCH channel (for example if the TCI state is configured as Rel-15 or Rel-16 legacy TCI state ID).

Some embodiments include UE actions upon determining the downlink BWP of target cell to be considered active. Upon determining which downlink BWP is considered active, according to at least one of the solutions disclosed, the UE performs one of more of the actions according to one or more of the following.

Some embodiments include downlink channel configuration of the target candidate cell. In a set of embodiments, the UE, upon reception of the L1/L2 inter-cell mobility execution command, selects and uses at least one downlink channel configuration (e.g., PDSCH configuration, PDCCH configuration, core resource set (CORESET) configuration, etc.) for monitoring (receiving) information from the target candidate cell (e.g., to receive downlink control information (DCI) and/or data) associated to the downlink BWP indicated to be activated. The selection process is used because the UE may have multiple configurations for a given downlink channel (e.g., multiple PDCCH configurations), each associated to one of the multiple downlink BWP(s) of the SpCell configuration. The UE uses the selected downlink channel configuration and receives downlink information from the target candidate cell.

Some embodiments include TCI state configuration of target candidate cell. In a set of embodiments, the UE receives the L1/L2 inter-cell mobility execution command and selects at least one TCI state to be considered activated, wherein the indicated TCI state(s) being associated to the downlink BWP that is indicated to be activated. The UE uses the selected TCI state to receive downlink information from the target candidate cell, as the selected TCI state indicates a spatial direction in which the UE receives information from the target candidate cell. In one variant, the UE determines the downlink BWP indicated to be the active one and within the downlink BWP configuration the UE finds a downlink channel configuration (e.g., PDCCH configuration) and, within the downlink channel configuration the UE finds the list of TCI states from which it selects the TCI state of the target cell to consider active for the downlink channel.

The L1/L2 inter-cell mobility execution command may contain a pointer to a TCI state (e.g., a TCI state ID) that refers to a downlink channel configuration in one of the configured TCI states in the BWP indicated to be activated. If the UE receives in the L1/L2 inter-cell mobility execution command the TCI ID=2 for PDCCH, the TCI state to consider active for PDCCH is the TCI state with TCI state=2 configured for PDCCH in the downlink BWP considered to be active upon L1/L2 inter-cell mobility execution. This helps the UE interpret the pointer to a TCI state included in the L1/L2 inter-cell mobility execution command, in the sense that the UE knows in which list to look for the TCI state, i.e., the list within the downlink BWP considered to be considered active, resolving the ambiguity.

In another example, uplink TCI state ID is determined based on the SSB ID associated with the contention free random access preamble configured or indicated in the L1/L2 inter-cell mobility execution command. For example, if the RACH is performed based on the SSB ID 0, then the TCI state that is QCLed with the SSB ID 0 is assumed as the uplink TCI state for the first transmission (and also for the subsequent transmission until the TCI state ID is updated) in the uplink.

In some embodiments, downlink TCI state ID is determined based on the SSB ID associated with the contention based random access preamble chosen/transmitted to gNB (e.g., indicated in L1/L2 inter-cell mobility execution command to determine the TCI state ID based on the SSB ID used to determine the RACH preamble). For example, if the RACH is performed based on the SSB ID 0, then the downlink TCI state ID that is QCLed with the SSB ID 0 is assumed as the downlink TCI state ID for the first transmission (and also for the subsequent transmission until the UL spatial relation information ID is updated) in the downlink.

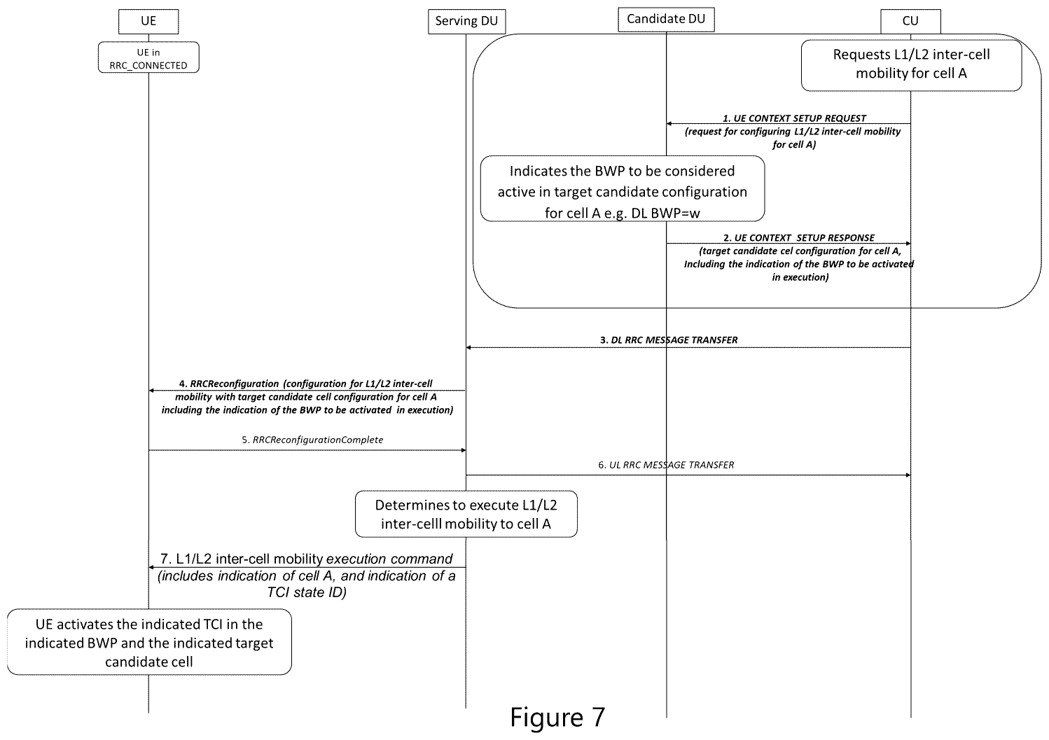

In one example, using signaling solution 1 for the BWP indication, the UE receives the L1/L2 inter-cell mobility execution command (e.g., MAC CE) in which the pointer to a TCI state corresponds to an indication of a TCI state (e.g., a TCI state ID), e.g., the MAC CE includes a field indicating the TCI state ID for the BWP to be activated. Upon reception, the UE determines the downlink BWP and/or uplink BWP to be considered activated in the target candidate cell upon L1/L2 inter-cell mobility, and consequently the associated TCI states configured in the downlink BWP indicated to be activated. By knowing the BWP to be considered activated the UE finds the list of relevant TCI state configuration(s) in which it identifies the TCI state whose TCI state ID has been indicated in the L1/L2 inter-cell mobility execution command. An example is illustrated in FIG. 7.

FIG. 7 is a signaling diagram illustrating the signaling of Solution 1, described above. In one example, using signaling solution 1 for the BWP indication, the UE has received in the target candidate configuration the indication of the downlink BWP to be activated, such as the field “firstActiveDownlinkBWP-Id”, that is set to a value associated to a BWP ID of one of the configured downlink BWPs of the target candidate cell. The indication, e.g. “firstActiveDownlinkBWP-Id” in the target candidate cell configuration indicated in the L1/L2 inter-cell mobility execution command is set to ‘w’, so the downlink BWP configuration in which the UE finds the relevant TCI states for L1/L2 inter-cell mobility execution is the downlink BWP configuration of the target candidate cell in which the BWP Id is ‘w’. The indicated downlink BWP has a set of TCI states, e.g., TCI state 1, TCI state 2, TCI state 3, e.g., for the PDCCH. If the L1/L2 inter-cell mobility execution command further indicates the TCI state ID=2, the UE knows the TCI state to be activated is the TCI state whose ID=2 within the downlink BWP indicated to be activated (regardless if other downlink BWPs also have a TCI state whose TCI state ID=2). The UE determines how it shall listen to (or monitor) control information in the downlink in the target candidate cell upon L1/L2 inter-cell mobility execution using the indication of the TCI state and downlink BWP to be considered activated.

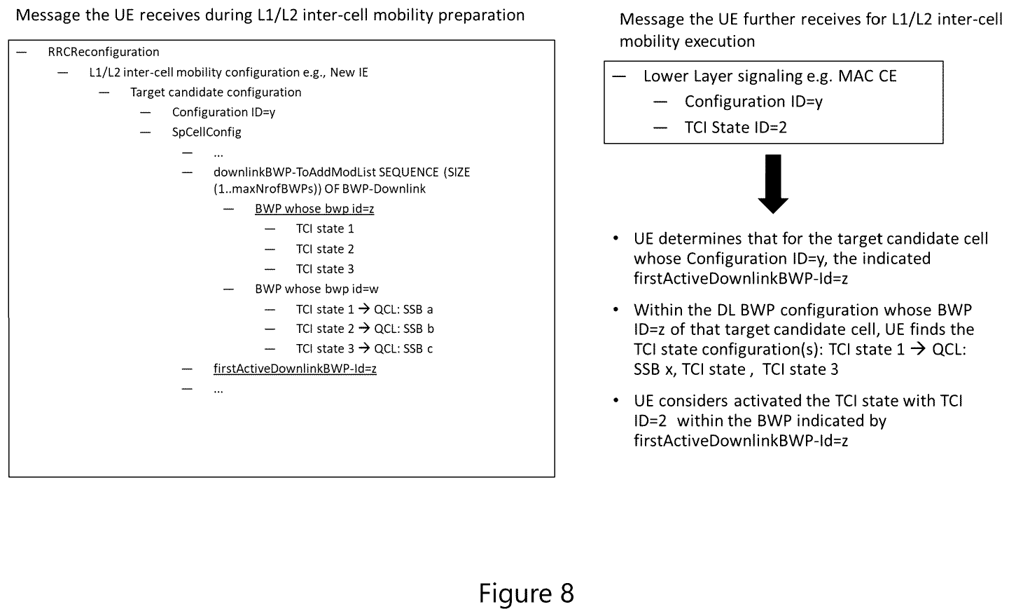

FIG. 8 is a more detailed example of signaling solution 1, according to particular embodiments. The illustrated example illustrates the message a UE receives during L1/L2 inter-cell mobility preparation on the left and the message the UE further receives for L1/L2 inter-cell mobility execution on the right.

Some embodiments include TCI state indication for uplink and downlink of the target cell. In one example, the L1/L2 inter-cell mobility execution command may comprise at least one TCI state indication (e.g., TCI state ID) for the uplink direction and at least one TCI state indication (e.g., TCI state ID) for the downlink direction. In this case, the TCI state indication for the downlink direction corresponds to a TCI state configured in the downlink BWP to be considered activated upon L1/L2 inter-cell mobility execution, and the TCI state indication for the uplink direction corresponds to a TCI State configured in the uplink BWP to be considered activated upon L1/L2 inter-cell mobility execution. The UE determines how it shall transmit information (e.g., scheduling requests) in the uplink in the target candidate cell upon L1/L2 inter-cell mobility execution, using the indication of the TCI state and uplink BWP to be considered active and how the UE shall listen to (or monitor) control information in the downlink in the target candidate cell upon L1/L2 inter-cell mobility execution, using the indication of the TCI state and downlink BWP to be considered activated.

In some embodiments the downlink TCI indication in the L1/L2 inter-cell mobility execution command may contain only one TCI state ID for all the downlink channels (PDCCH, PDSCH). In some embodiments, the downlink TCI indication in the L1/L2 inter-cell mobility execution command may contain one TCI state ID for the PDCCH channel and one TCI state ID for the PDSCH channel or one TCI state ID for the PDCCH channel which in turn indicates the TCI state ID for PDSCH as well.

In some embodiments, the source DU may not know the TCI state information in the target DU, and in those scenarios, beam information may be used instead of TCI state information.

Some embodiments use the downlink beam of the target candidate cell. The method further comprises the UE, upon reception of the L1/L2 inter-cell mobility execution command, selecting at least one downlink beam (or downlink spatial direction) and considers it to be the one to be monitored, wherein the selected downlink beam(s) being associated to the downlink BWP that is indicated to be activated. The selection process is needed because the UE may have configured downlink beam lists for the target candidate cell, each list associated to one of the multiple downlink BWP(s) of the SpCell configuration.

The UE uses the selected downlink beam to receive downlink information from the target candidate cell, as the selected downlink beam indicates a spatial direction in which the UE receives information from the target candidate cell. In one variant, the UE determines the downlink BWP indicated to be the active one and within that downlink BWP configuration the UE finds a downlink channel configuration (e.g., PDCCH configuration) and, within the downlink channel configuration the UE finds the downlink beam list from which it selects the downlink beam of the target cell to consider active for the downlink channel. In one example, the L1/L2 inter-cell mobility execution command contains a pointer to a downlink beam (e.g., a downlink beam ID) that refers to a downlink channel configuration in one of the configured downlink beams in the BWP indicated to be activated. If the UE receives in the L1/L2 inter-cell mobility execution command the downlink beam ID=2 for PDCCH (or PDSCH, or both, e.g., unified), the downlink beam to consider active for PDCCH (or PDSCH, or both, e.g., unified) is the downlink beam with Beam ID=2 configured for PDCCH (or PDSCH, or both, e.g., unified) in the downlink BWP considered to be active upon L1/L2 inter-cell mobility execution. This helps the UE interpret the pointer to a downlink beam included in the L1/L2 inter-cell mobility execution command, in the sense that the UE knows in which list to look for the downlink beam, i.e., the list within the downlink BWP considered to be considered active, resolving the ambiguity.

Some embodiments include a downlink reference signal identifier of the target candidate cell. The method further comprises the UE, upon reception of the L1/L2 inter-cell mobility execution command, selecting at least one reference signal (e.g., SSB associated to an SSB index, or CSI-RS resource associated to a CSI-RS identifier) and consider it to be the QCL source, i.e. correlated in the spatial domain with a channel (e.g., PDCCH), wherein the selected reference signal is associated to the downlink BWP that is indicated to be activated. The selection process is needed because the UE may have configured reference signal lists for the target candidate cell, each list associated to one of the multiple downlink BWP(s) of the SpCell configuration. The UE uses the selected RS to receive downlink information from the target candidate cell, as the selected reference signal indicates a spatial direction correlated with the spatial direction in which the UE receives information from the target candidate cell.

In one variant, the UE determines the downlink BWP indicated to be the active one and within the downlink BWP configuration the UE finds a downlink channel configuration (e.g., PDCCH configuration) and, within the downlink channel configuration the UE finds the reference signal list from which the UE selects the reference signal of the target cell to consider active for the downlink channel. In one example, the L1/L2 inter-cell mobility execution command contains a pointer to a reference signal (e.g., a reference signal ID, such as an SSB index) that refers to a downlink channel configuration in one of the configured reference signals (e.g., configured as QCL source in a TCI state configuration) in the BWP indicated to be activated. If the UE receives in the L1/L2 inter-cell mobility execution command the SSB index=2 for PDCCH (or PDSCH, or both, e.g., unified), the downlink beam and/or TCI state to consider active for PDCCH (or PDSCH, or both, e.g., unified) is the beam and/or TCI state whose QCL source (e.g., type D) has configured SSB index=2 for PDCCH (or PDSCH, or both, e.g., unified) in the downlink BWP considered to be active upon L1/L2 inter-cell mobility execution. This helps the UE interpret the pointer to a reference signal ID included in the L1/L2 inter-cell mobility execution command, in the sense that the UE knows in which list to look for the reference signal, i.e., the list within the downlink BWP to be considered active, resolving the ambiguity.

In a set of embodiments, the L1/L2 inter-cell mobility execution command the UE receives may further include an indication of at least one SSB index, wherein the SSB index is associated to an SSB configured as a QCL source of the TCI state to be activated by the UE in the target candidate cell, e.g. a MAC CE including a field indicating the SSB index for an SSB configured as QCL source of a TCI state to be activated in the BWP indicated to be activated. Upon reception, the UE determines the downlink BWP and/or uplink BWP to be considered activated in the target candidate cell upon L1/L2 inter-cell mobility, and consequently the associated TCI States configured in the downlink BWP indicated to be activated. By knowing the BWP to be considered activated the UE finds the list of relevant TCI state configuration(s) in which it identifies the TCI state whose indicated SSB index is configured as QCL source (e.g., type D).

In one example, the UE has received in the target candidate configuration the indication of the downlink BWP to be activated, such as the field “firstActiveDownlinkBWP-Id”, that is set to a value associated to a BWP ID of one of the configured downlink BWPs of the target candidate cell. The indication, e.g. “firstActiveDownlinkBWP-Id” in the target candidate cell configuration indicated in the L1/L2 inter-cell mobility execution command is set to ‘w’, so the downlink BWP configuration in which the UE finds the relevant TCI states for L1/L2 inter-cell mobility execution is the downlink BWP configuration of the target candidate cell in which the BWP ID is ‘w’. The indicated downlink BWP has a set of TCI states associated to a reference signal (such as an SSB indicated by an SSB index) configured as QCL source of a TCI state, e.g. TCI state 1→QCL: SSB x, TCI state 2→QCL: SSB y, TCI state 3→QCL: SSB z, e.g., for the PDCCH. If the L1/L2 inter-cell mobility execution command further indicates the SSB index y, the UE knows the TCI state to be activated is the TCI state whose QCL source is SSB y within the downlink BWP indicated to be activated (regardless if other downlink BWPs also have SSB y as QCL source). The UE determines how it shall listen to (or monitor) control information in the downlink in the target candidate cell upon L1/L2 inter-cell mobility execution using the indication of the TCI state and downlink BWP to be considered activated.

Some embodiments include uplink BWP and SSB index, e.g., for an uplink channel like PUCCH and/or PUSCH. In one example, the UE has received in the target candidate configuration the indication of the uplink BWP to be activated, such as the field “firstActiveUplinkBWP-Id”, which is set to a value associated to a BWP ID of one of the configured uplink BWPs of the target candidate cell. The indication, e.g. “firstActiveUplinkBWP-Id” in the target candidate cell configuration indicated in the L1/L2 inter-cell mobility execution command is set to ‘w’, so the uplink BWP configuration in which the UE finds the relevant TCI states for L1/L2 inter-cell mobility execution is the uplink BWP configuration of the target candidate cell in which the BWP ID is ‘w’. The indicated uplink BWP has a set of TCI states associated to a reference signal (such as an SSB indicated by an SSB index) configured as QCL source of a TCI state, e.g., TCI state 1→QCL: SSB x, TCI state 2→QCL: SSB y, TCI state 3→QCL: SSB z, e.g., for the PUCCH. If the L1/L2 inter-cell mobility execution command further indicates the SSB index y, the UE knows the TCI state to be activated is the TCI state whose QCL source is SSB y within the uplink BWP indicated to be activated (regardless if other uplink BWPs also have SSB y as QCL source). The UE determines how it shall listen to (or monitor) control information in the uplink in the target candidate cell upon L1/L2 inter-cell mobility execution using the indication of the TCI state and uplink BWP to be considered activated.

In another example, the L1/L2 inter-cell mobility execution command may comprise at least one SSB index for the uplink direction and at least one SSB index for the downlink direction. In that case, the SSB index for the downlink direction corresponds to the QCL source of a TCI state configured in the downlink BWP to be considered activate upon L1/L2 inter-cell mobility execution. SSB index for the uplink direction corresponds to a TCI state configured in the uplink BWP to be considered activate upon L1/L2 inter-cell mobility execution. The UE determines how it shall transmit information (e.g., scheduling requests) in the uplink in the target candidate cell upon L1/L2 inter-cell mobility execution using the indication of the TCI state and uplink BWP to be considered active and how the UE shall listen to (or monitor) control information in the downlink in the target candidate cell upon L1/L2 inter-cell mobility execution using the indication of the TCI state and downlink BWP to be considered activated.

An additional advantage of these examples is to the serving DU, at the network side. The fact that the UE receives an SSB index instead of a TCI state ID in the L1/L2 inter-cell mobility execution command means that the serving DU does not need to know the mapping between SSB indexes and TCI states of a target candidate cell, which facilitates the serving DU implementation and the network signaling between CU and DU as the serving DU takes decisions for which SSB to indicate in the L1/L2 inter-cell mobility execution command based on reports of measurements (e.g., L1 RSRP CSI reports for an SSB index) associated to an SSB index.

Although SSB index has been used as an example, the embodiments are applicable to any reference signal identifier or index, or synchronization signal identifier or index, wherein the reference signal or synchronization signal is configured as a QCL source of a TCI state.

Some embodiments include beam indication. The L1/L2 inter-cell mobility execution command the UE receives may further include an indication of at least a beam (e.g., beam identifier), wherein the beam identifier is associated to a beam or spatial direction in which signals and control channels are configured, e.g. a MAC CE including a field indicating the beam ID or index configured for a TCI state to be activated in the BWP indicated to be activated. Upon reception, the UE determines the downlink BWP and/or uplink BWP to be considered activated in the target candidate cell upon L1/L2 inter-cell mobility, and consequently the associated TCI states configured in the downlink BWP indicated to be activated. By knowing the BWP to be considered activated the UE finds the list of relevant TCI state configuration(s) in which it identifies the TCI state whose indicated beam index or identifier is configured as a QCL source (e.g., type D).

Some embodiments include measurements. The method further comprises the UE, upon reception of the L1/L2 inter-cell mobility execution command, selecting at least one reference signal (e.g., SSB associated to an SSB index, or CSI-RS resource associated to a CSI-RS identifier) and performing measurements on the selected reference signal wherein the selected reference signal is associated to the downlink BWP that is indicated to be activated. The UE may include the measurements on the selected reference signals in subsequent measurement reports.

Some embodiments include determining reference signals of target candidate cell(s) for measurements. Particular embodiments include determining beam measurements to perform based on the indicated active BWP.

In a set of embodiments, the UE determines one or more reference signal(s) of a target candidate cell for L1/L2 inter-cell mobility to be measured and/or reported to the network, e.g. SSB(s) and/or CSI-RS resources, based on the indication of at least one of the configured BWP(s) of the target candidate cell to be activated (not upon reception of the message, but upon L1/L2 inter-cell mobility execution). The indication is included in the one target candidate cell configuration the UE receives in the L1/L2 inter-cell mobility configuration. In one example, the UE does not only rely exclusively on a CSI measurement configuration to determine the reference signals to be measured to assist L1/L2 inter-cell mobility but, the UE relies at least partially on the target candidate cell configuration, more specifically on the downlink BWP configuration of the target candidate cell configuration, indicated to be activated upon L1/L2 inter-cell mobility execution to that target candidate cell. In other words, to determine which SSBs and/or CSI-RS resources to measure and report, the UE checks the indicated SSBs and/or CSI-RS resources (identified by their respective indexes and/or identifiers) configured in the downlink BWP configuration indicated to be considered activated in the target candidate cell when the UE executes L1/L2 inter-cell mobility to the target candidate cell. The QCL source configuration for a TCI state may include a reference signal identity or index, based on which the UE determines which reference signal to measure, e.g. SSB index and/or CSI-RS resource identifier. For CSI-RS, for example, the UE determines further configuration for a given resource in a CSI measurement configuration.

In a set of embodiments, the UE performs one or more measurements to be reported to the network, such as RSRP, RSRQ, SINR, wherein these measurements are on one or more reference signal(s) of a target candidate cell for L1/L2 inter-cell mobility, e.g. measurements on one or more SSB(s) and/or CSI-RS resources of that target candidate cell for L1/L2 inter-cell mobility. The reference signals are determined by the UE based on the indication of at least one of the configured BWP(s) of the target candidate cell to be activated (not upon reception of the message) in the one target candidate cell configuration the UE receives in the L1/L2 inter-cell mobility configuration.

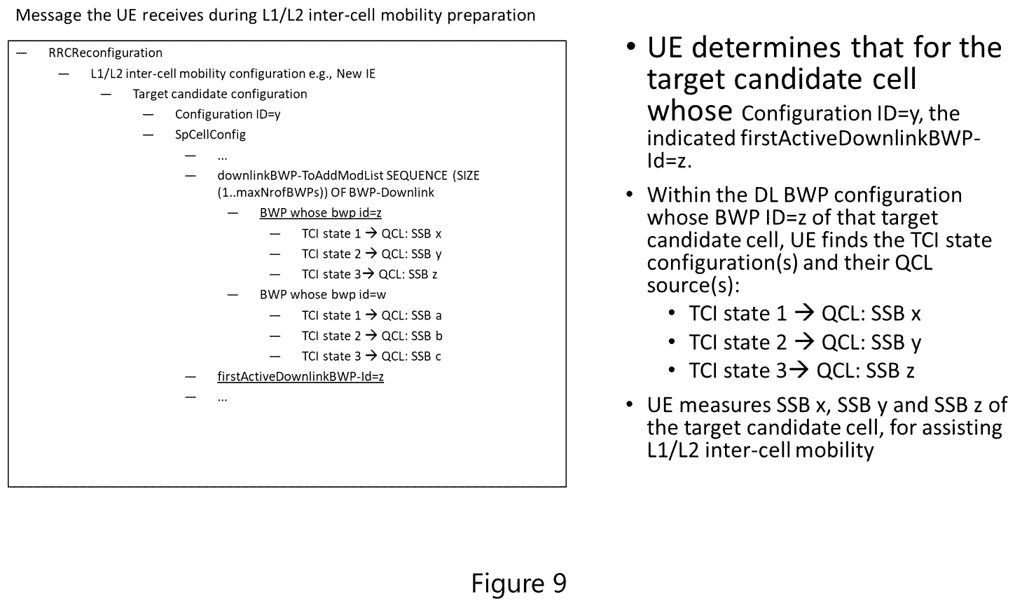

In one embodiment, the UE performs one or more measurements to be reported to the network, such as RSRP, RSRQ, SINR, on one or more reference signals of a target candidate cell for L1/L2 inter-cell mobility, e.g. SSB(s) and/or CSI-RS resources which are configured as a QCL source (e.g., of Type D) of TCI state(s) configured in the downlink BWP indicated to be activated upon execution of L1/L2 inter-cell mobility. In one example, the indication of the configured downlink BWP to the target candidate cell, to be activated, corresponds to the field “firstActiveDownlinkBWP-Id” that is set to a value associated to a BWP ID of one of the configured downlink BWPs of the target candidate cell. For example, if the “firstActiveDownlinkBWP-Id” is set to ‘w’, the downlink BWP configuration in which the UE finds the reference signals to be measured is the downlink BWP configuration of the target candidate cell in which the BWP ID is ‘w’. The indicated downlink BWP has a set of TCI states, each with a reference signal configured as QCL sources, wherein the UE measures the reference signals configured as QCL source(s) of the TCI states. An example is illustrated in FIG. 9.

FIG. 9 is another detailed example of signaling solution 1, according to particular embodiments. The illustrated example illustrates the message a UE receives during L1/L2 inter-cell mobility preparation on the left and the message the UE further receives for L1/L2 inter-cell mobility execution on the right.

If the UE is configured in the L1/L2 inter-cell mobility configuration with multiple target candidate cells, the UE receives multiple target candidate cell configuration(s), e.g. a set or list of CellGroupConfig(s), RRCReconfiguration(s), SpCellConfig(s), each for a target candidate cell. Then, the UE performs the measurements for each of the target candidate cell(s) according to the method, as each target candidate cell configuration indicated a downlink BWP to be considered activated for L1/L2 inter-cell mobility execution.

A benefit of using the indicated downlink BWP to determine the reference signals to measure is that the UE limits the measurements it needs to perform on a target candidate cell by measuring reference signals on the downlink BWP that is to be considered active when/if the UE moves/switches to the target candidate cell, instead of measuring all possible reference signals that may be detected by the UE for the target candidate cell.

On the network side, a candidate DU, responsible for a target candidate cell and generating a target candidate cell configuration, determines what is the downlink BWP that is to be considered activated for L1/L2 inter-cell mobility execution to that cell and indicates that in the target candidate cell configuration. In addition, as the UE would measure the reference signals in that indicated downlink BWP, the candidate DU transmits the reference signals of the indicated downlink BWP, e.g. CSI-RS resources and/or SSBs in the BWP to be activated upon L1/L2 inter-cell mobility execution.

Some embodiments determine the BWP ID to be included in the L1/L2 inter-cell mobility execution command. According to the described solutions, the UE receives a L1/L2 inter-cell mobility execution command that includes an indication of which BWP to use when the L1/L2 inter-cell mobility is executed towards an indicated target candidate cell for L1/L2 inter-cell mobility

To achieve this, in one embodiment, the serving DU before sending the L1/L2 inter-cell mobility execution command to the UE may send an explicit request to the candidate DU that has configured the selected target candidate cell for L1/L2 inter-cell mobility to ask for which BWP (i.e., uplink and/or downlink BWP) to be indicated to the UE. The candidate DU may reply to the serving DU with the BWP (i.e., uplink and/or downlink BWP) to be indicated to the UE. If the serving DU wants to override the BWP(s) to be used that were already indicated to the target candidate cell for L1/L2 inter-cell mobility configuration the serving DU may ignore the request received by the serving DU. The latter case is an indication for the serving DU that the UE should use the BWP(s) already indicated or configured with the target candidate cell for L1/L2 inter-cell mobility configuration. In an alternative of the latter case, to improve the latency (because the serving DU does not need to wait a certain time before determining that the candidate DU does not want to provide any BWP identifier(s)), the candidate DU may reply to the serving DU with an empty field, information element, structure for what concern the BWP(s) that the UE needs to use.

In another embodiment, the candidate DU when providing the a target candidate cell for L1/L2 inter-cell mobility configuration (via the serving DU) to the UE, it indicates in a separate field, structure, information element within an F1AP message (that is the same that carried the target candidate cell for L1/L2 inter-cell mobility configuration) which BWP(s) the UE should use if this target candidate cell for L1/L2 inter-cell mobility is indicated in the L1/L2 inter-cell mobility execution command. If the Candidate DU wants to change in a later moment which BWP(s) should be used for a target candidate cell for L1/L2 inter-cell mobility configuration, the candidate DU needs to send a new F1AP message to the serving DU for informing about the new BWP(s) to be used by the UE if this target candidate cell for L1/L2 inter-cell mobility is indicated in the L1/L2 inter-cell mobility execution command.

The messages that go from the serving DU to the candidate DU (and vice versa) go via the CU (Serving DU→CU→Candidate DU→CU→Serving DU).

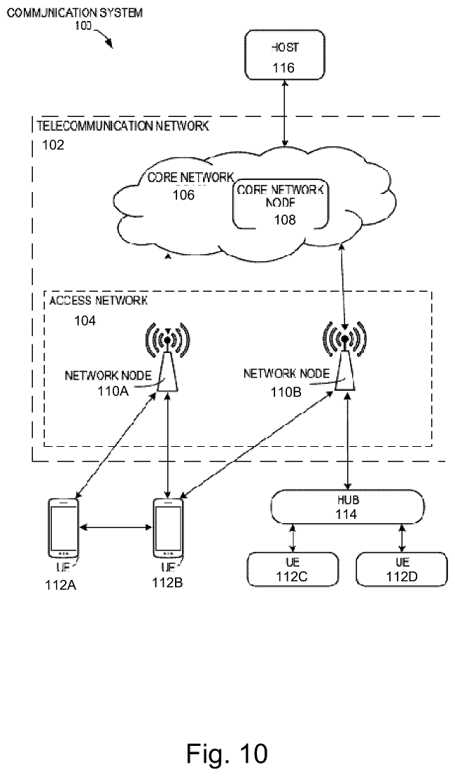

FIG. 10 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G. 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

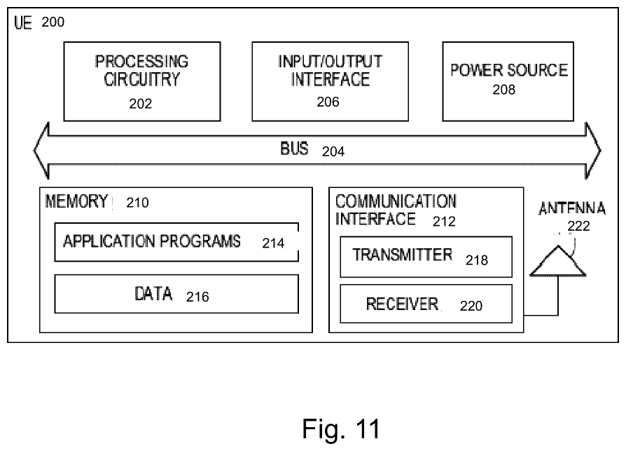

FIG. 11 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

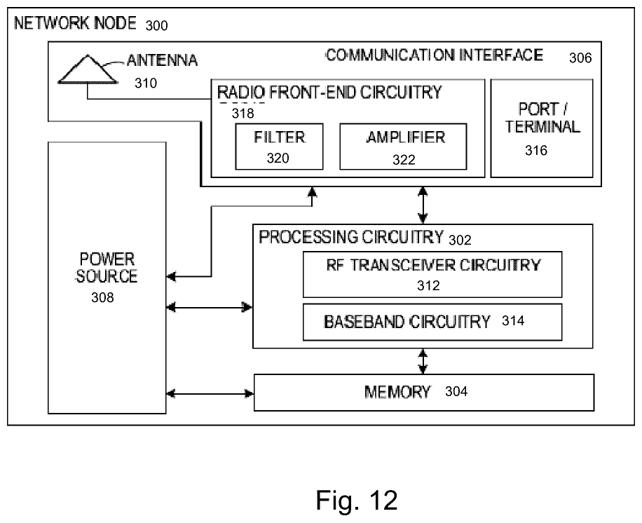

FIG. 12 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 12 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

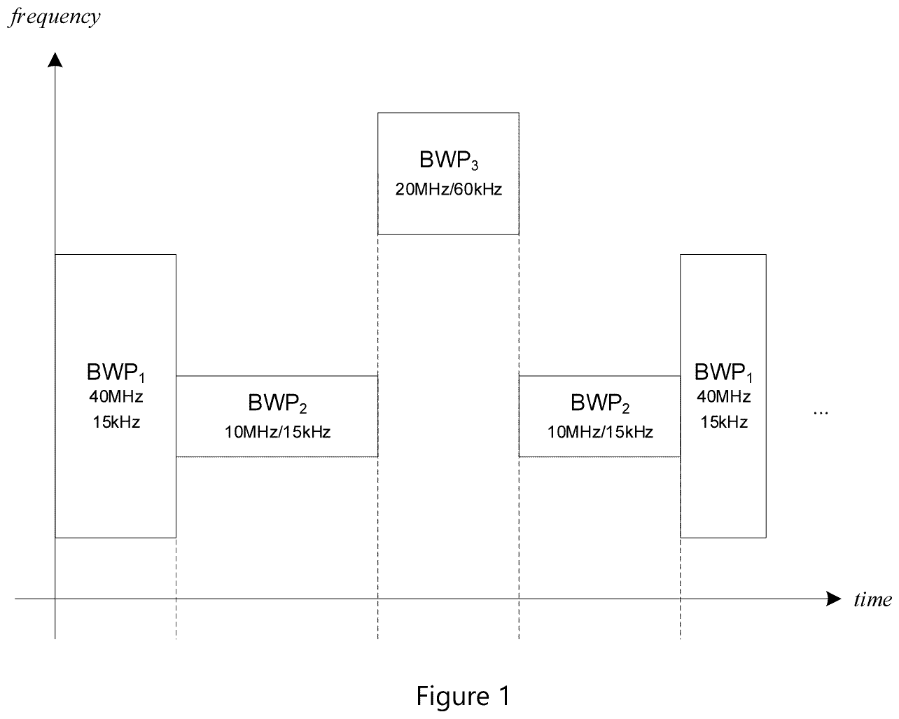

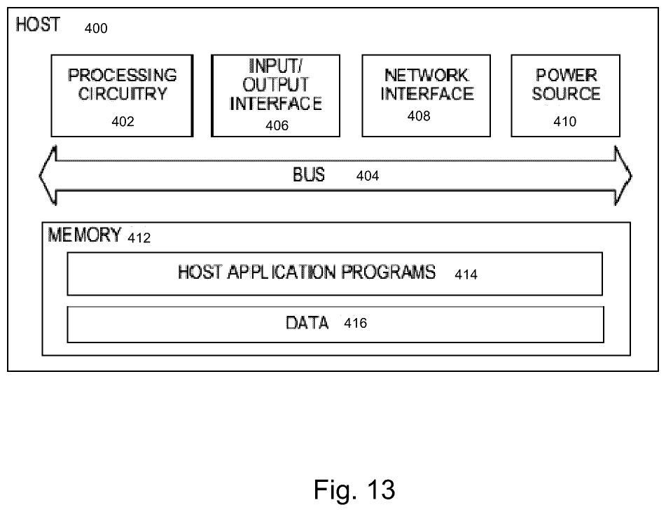

FIG. 13 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

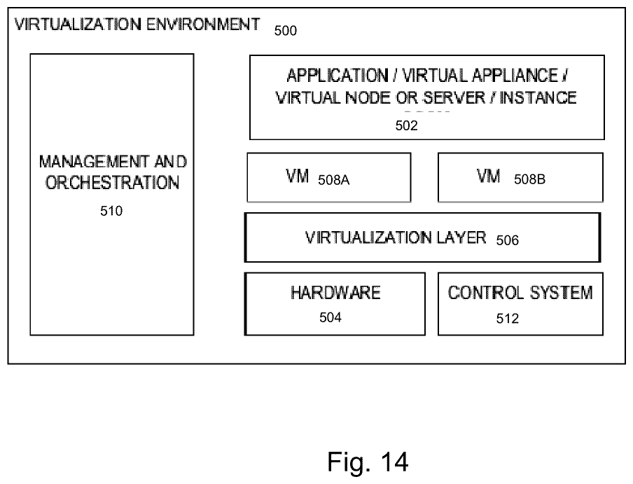

FIG. 14 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

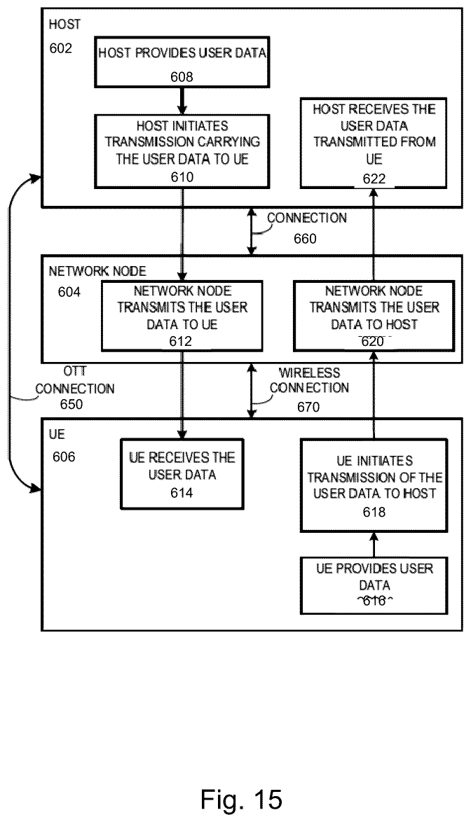

FIG. 15 shows a communication diagram of a host 602 communicating via a network node 604 with a UE 606 over a partially wireless connection in accordance with some embodiments. Example implementations, in accordance with various embodiments, of the UE (such as a UE 112a of FIG. 10 and/or UE 200 of FIG. 2), network node (such as network node 110a of FIG. 10 and/or network node 300 of FIG. 3), and host (such as host 116 of FIG. 10 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate and latency and thereby provide benefits such as reduced user waiting time, better responsiveness, and better QoE.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

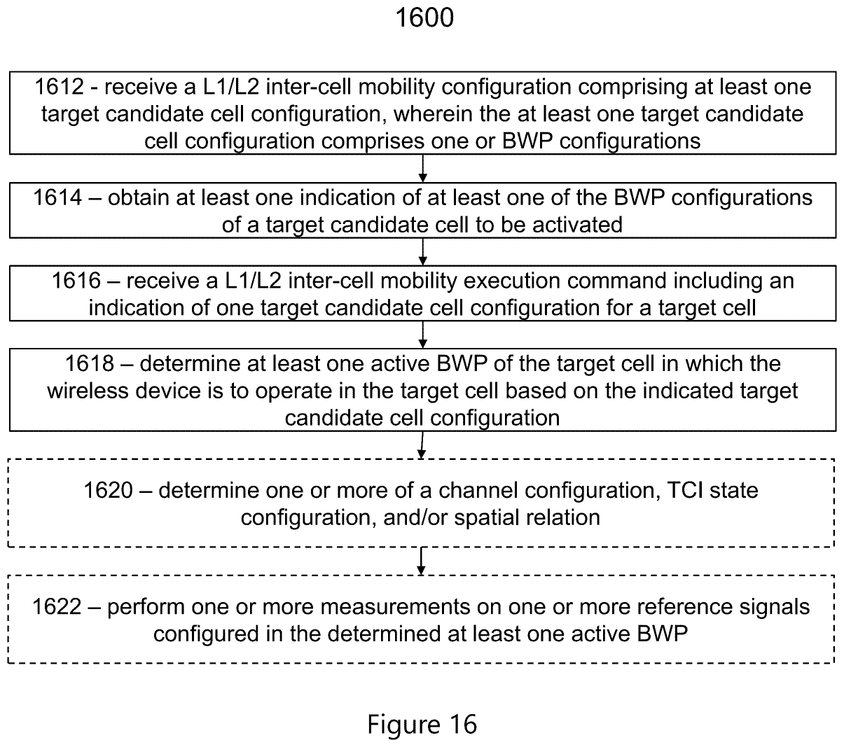

FIG. 16 is a flowchart illustrating an example method in a wireless device, according to certain embodiments. In particular embodiments, one or more steps of FIG. 16 may be performed by UE 200 described with respect to FIG. 11. The wireless device is capable of L1/L2 inter-cell mobility.

The method begins at step 1612, where the wireless device (e.g., UE 200) receives a L1/L2 inter-cell mobility configuration comprising at least one target candidate cell configuration. The at least one target candidate cell configuration comprises one or more BWP configurations. In particular embodiments, the one or more BWP configurations comprise one or more configurations for one or more downlink BWPs, one or more uplink BWPs, and one or more uplink and downlink BWPs.

In particular embodiments, the target candidate cell configuration is generated by a candidate distributed unit (DU) associated with the target candidate cell configured for L1/L2 inter-cell mobility.

To perform the mobility more efficiently, it is beneficial if the wireless device knows which of the one or more BWP configurations will be activated after a mobility operation.

At step 1614, the wireless device obtains at least one indication of at least one of the BWP configurations of a target candidate cell to be activated. In particular embodiments, obtaining the at least one indication of the BWP configurations of the target candidate cell to be activated comprises receiving the indication in the at least one target candidate cell configuration, receiving the indication in the received L1/L2 inter-cell mobility execution command, or receiving the indication in a Radio Resource Control (RRC) message. In particular embodiments, the wireless device may obtain the indication according to any of the embodiments and examples described herein.

At step 1616, the wireless device receives a L1/L2 inter-cell mobility execution command including an indication of one target candidate cell configuration for a target cell. In particular embodiments, the L1/L2 inter-cell mobility execution command further includes an indication of one or more TCI state configurations. In particular embodiments, the L1/L2 inter-cell mobility execution command may include any of the information in the embodiments and examples described herein.

At step 1618, the wireless device determines at least one active BWP of the target cell in which the wireless device is to operate in the target cell based on the indicated target candidate cell configuration.

At step 1620, the wireless device, based on the determination of the at least one active BWP, may determine one or more of: one or more downlink channel configuration associated with the determined at least one active BWP; one or more uplink channel configuration associated with the determined at least one active BWP; one or more transmission configuration indication (TCI) state configuration associated with the determined at least one active BWP; one or more TCI state configuration associated with a downlink channel of the target cell: one or more TCI state configuration associated with an uplink channel of the target cell; and one or more spatial relation configuration associated with the determined at least one active BWP. Determining one or more TCI state configuration associated with the determined at least one active BWP may further comprise determining a TCI state to be activated based on a TCI state identifier included in the L1/L2 inter-cell mobility execution command.

In particular embodiments, based on the determination of the at least one active BWP, the wireless device may determine any of the information described in the embodiments and examples described herein.

At step 1622, the wireless device may perform one or more measurements on one or more reference signals configured in the determined at least one active BWP. For example, the wireless device may detect an SSB for the at least one active BWP. In particular embodiments, the wireless device may perform any of the operations on the at least one active BWP described in the embodiments and examples described herein.

Modifications, additions, or omissions may be made to method 1600 of FIG. 16. Additionally, one or more steps in the method of FIG. 16 may be performed in parallel or in any suitable order.

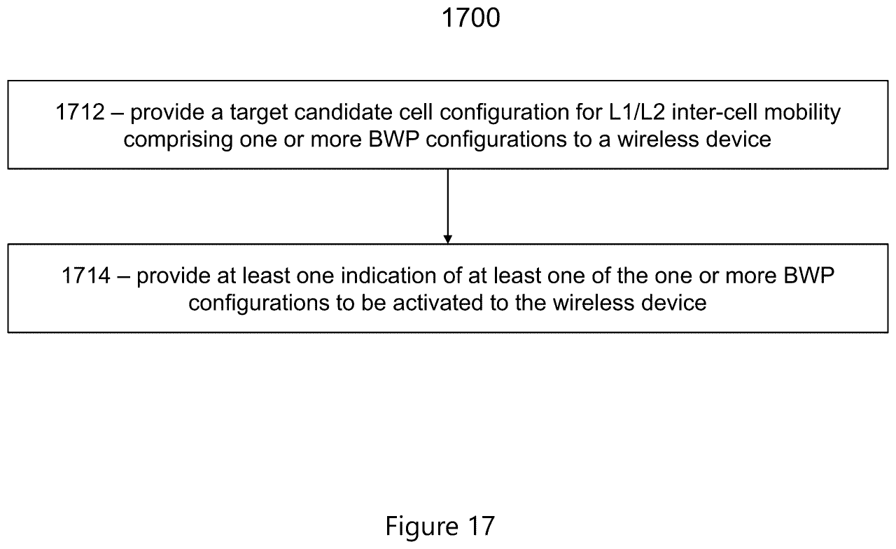

FIG. 17 is a flowchart illustrating an example method in a network node, according to certain embodiments. In particular embodiments, one or more steps of FIG. 17 may be performed by network node 300 described with respect to FIG. 12. The network node is capable of L1/L2 inter-cell mobility. In particular embodiments, the network node comprises a candidate distributed unit (DU) associated with a target candidate cell configured for L1/L2 inter-cell mobility.

The method begins at step 1712, where the network node (e.g., network node 300) provides a target candidate cell configuration for L1/L2 inter-cell mobility comprising one or more BWP configurations to a wireless device (e.g., UE 200).

In particular embodiments, providing the at least one indication of the BWP configurations to be activated comprises providing the indication in the target candidate cell configuration, providing the indication as part of a L1/L2 inter-cell mobility execution command, or providing the indication in a RRC message.

In particular embodiments, the one or more BWP configurations comprise one or more configurations for one or more downlink BWPs, one or more uplink BWPs, and one or more uplink and downlink BWPs.

At step 1714, the network node provides at least one indication of at least one of the one or more BWP configurations to be activated to the wireless device.

Modifications, additions, or omissions may be made to method 1700 of FIG. 17. Additionally, one or more steps in the method of FIG. 17 may be performed in parallel or in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device capable of L1/L2 inter-cell mobility, the method comprising:
   receiving a L1/L2 inter-cell mobility configuration, comprising at least one target candidate cell configuration, wherein the one target candidate cell configuration comprises an associated identifier for referring to the one target candidate cell configuration and multiple BWP configuration(s) of a type;
   obtaining at least one indication of at least one of the configured BWP(s) of the target candidate cell to be activated:
   receiving a L1/L2 inter-cell mobility execution command including an indication of the one target candidate cell configuration, referring to the identifier associated to the one target candidate cell configuration; and
   determining at least one active BWP of the target candidate cell in which the wireless device is to operate in the target candidate cell based on the indicated target candidate cell configuration.
2. The method of embodiment 1, further comprising obtaining the indication of the BWP to be considered active in the target candidate cell configuration, as a field, parameter and/or information element.
3. The method of embodiment 1, further comprising obtaining the indication of the BWP to be considered active in the L1/L2 inter-cell mobility execution command the UE receives.
4. The method of embodiment 1, wherein the multiple configured BWP(s) comprise one or more of: one or more DL BWP(s), one or more UL BWP(s), and one or more UL and DL BWP(s).
5. The method of embodiment 1, wherein the uplink configuration for a target candidate cell is generated by a Candidate DU, associated to the target candidate cell configured for L1/L2 inter-cell mobility.
6. The method of embodiment 1, further comprising determining based on the indication of the BWP to be considered active one or more of:
   one or more DL channel configuration(s) associated to the indicated DL BWP;
   one or more UL channel configuration(s) associated to the indicated UL BWP;
   one or more TCI state configuration(s) associated to the indicated DL and/or UL BWP;
   one or more TCI state configuration(s) associated to a DL channel of the target cell:
   one or more UL spatial relation(s) configuration(s) associated to the indicated UL BWP;
   one or more TCI state configuration(s) associated to at least one DL channel and at least one UL channel of the target cell.
7. The method of embodiment 1, further comprising: performing one or more measurements for reporting on one or more Reference Signal(s) (RSs), wherein the one or more RSs are configured in the BWP indicated to be the one to be activated in L1/L2 inter-cell mobility execution.
8. A method performed by a wireless device, the method comprising:
   any of the wireless device steps, features, or functions described above, either alone or in combination with other steps, features, or functions described above.
9. The method of the previous embodiment, further comprising one or more additional wireless device steps, features or functions described above.
10. The method of any of the previous embodiments, further comprising:
   providing user data; and
   forwarding the user data to a host computer via the transmission to the base station.

### Group B Embodiments

11. A method performed by a base station capable of L1/L2 inter-cell mobility, the method comprising:
   generating a target candidate cell configuration; and
   providing to a wireless device an indication of a configured BWP(s) of the target candidate cell.
12. A method performed by a base station, the method comprising:
   any of the steps, features, or functions described above with respect to base station, either alone or in combination with other steps, features, or functions described above.
13. The method of the previous embodiment, further comprising one or more additional base station steps, features or functions described above.
14. The method of any of the previous embodiments, further comprising:
   obtaining user data; and
   forwarding the user data to a host computer or a wireless device.

### Group C Embodiments

15. A mobile terminal comprising:
   processing circuitry configured to perform any of the steps of any of the Group A embodiments; and
   power supply circuitry configured to supply power to the wireless device.
16. A base station comprising:
   processing circuitry configured to perform any of the steps of any of the Group B embodiments;
   power supply circuitry configured to supply power to the wireless device.
17. A user equipment (UE) comprising:
   an antenna configured to send and receive wireless signals;
   radio front-end circuitry connected to the antenna and to processing circuitry, and configured to condition signals communicated between the antenna and the processing circuitry:
   the processing circuitry being configured to perform any of the steps of any of the Group A embodiments;
   an input interface connected to the processing circuitry and configured to allow input of information into the UE to be processed by the processing circuitry:
   an output interface connected to the processing circuitry and configured to output information from the UE that has been processed by the processing circuitry; and
   a battery connected to the processing circuitry and configured to supply power to the UE.
18. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
19. The communication system of the pervious embodiment further including the base station.
20. The communication system of the previous 2 embodiments, further including the UE, wherein the UE is configured to communicate with the base station.
21. The communication system of the previous 3 embodiments, wherein:
   the processing circuitry of the host computer is configured to execute a host application, thereby providing the user data; and
   the UE comprises processing circuitry configured to execute a client application associated with the host application.
22. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
23. The method of the previous embodiment, further comprising, at the base station, transmitting the user data.
24. The method of the previous 2 embodiments, wherein the user data is provided at the host computer by executing a host application, the method further comprising, at the UE, executing a client application associated with the host application.
25. A user equipment (UE) configured to communicate with a base station, the UE comprising a radio interface and processing circuitry configured to performs any of the previous 3 embodiments.
26. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
27. The communication system of the previous embodiment, wherein the cellular network further includes a base station configured to communicate with the UE.
28. The communication system of the previous 2 embodiments, wherein:
   the processing circuitry of the host computer is configured to execute a host application, thereby providing the user data; and
   the UE's processing circuitry is configured to execute a client application associated with the host application.
29. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
30. The method of the previous embodiment, further comprising at the UE, receiving the user data from the base station.
31. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
32. The communication system of the previous embodiment, further including the UE.
33. The communication system of the previous 2 embodiments, further including the base station, wherein the base station comprises a radio interface configured to communicate with the UE and a communication interface configured to forward to the host computer the user data carried by a transmission from the UE to the base station.
34. The communication system of the previous 3 embodiments, wherein:
   the processing circuitry of the host computer is configured to execute a host application; and
   the UE's processing circuitry is configured to execute a client application associated with the host application, thereby providing the user data.
35. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
36. A method implemented in a communication system including a host computer, a base station and a user equipment (UE), the method comprising:
   at the host computer, receiving user data transmitted to the base station from the UE, wherein the UE performs any of the steps of any of the Group A embodiments.
37. The method of the previous embodiment, further comprising, at the UE, providing the user data to the base station.
38. The method of the previous 2 embodiments, further comprising:
   at the UE, executing a client application, thereby providing the user data to be transmitted; and
   at the host computer, executing a host application associated with the client application.
39. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
40. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
41. The communication system of the previous embodiment further including the base station.
42. The communication system of the previous 2 embodiments, further including the UE, wherein the UE is configured to communicate with the base station.
43. The communication system of the previous 3 embodiments, wherein:
   the processing circuitry of the host computer is configured to execute a host application;
   the UE is configured to execute a client application associated with the host application, thereby providing the user data to be received by the host computer.
44. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
45. The method of the previous embodiment, further comprising at the base station, receiving the user data from the UE.
46. The method of the previous 2 embodiments, further comprising at the base station, initiating a transmission of the received user data to the host computer.

1. A method performed by wireless device capable of layer one (L1)/layer two (L2) inter-cell mobility, the method comprising:
receiving a L1/L2 inter-cell mobility configuration comprising at least one target candidate cell configuration, wherein the at least one target candidate cell configuration comprises one or more bandwidth part (BWP) configurations:
obtaining at least one indication of at least one of the BWP configurations of a target candidate cell to be activated:
receiving a L1/L2 inter-cell mobility execution command including an indication of one target candidate cell configuration for a target cell; and
determining at least one active BWP of the target cell in which the wireless device is to operate in the target cell based on the indicated target candidate cell configuration.

2. The method of claim 1, wherein obtaining the at least one indication of the BWP configurations of the target candidate cell to be activated comprises receiving the indication in the at least one target candidate cell configuration.

3. The method of claim 1, wherein obtaining the at least one indication of the BWP configurations of the target candidate cell to be activated comprises receiving the indication in the received L1/L2 inter-cell mobility execution command.

4. The method of claim 1, wherein obtaining the at least one indication of the BWP configurations of the target candidate cell to be activated comprises receiving the indication in a Radio Resource Control (RRC) message.

5. The method of claim 1, wherein the L1/L2 inter-cell mobility execution command further includes an indication of one or more transmission configuration indication (TCI) state configurations.

6. The method of claim 1, wherein the one or more BWP configurations comprise one or more configurations for one or more downlink BWPs, one or more uplink BWPs, and one or more uplink and downlink BWPs.

7. The method of claim 3, wherein the target candidate cell configuration is generated by a candidate distributed unit (DU) associated with the target candidate cell configured for L1/L2 inter-cell mobility.

8. The method of claim 1, further comprising:
based on the determination of the at least one active BWP, determining one or more of:
one or more downlink channel configuration associated with the determined at least one active BWP;
one or more uplink channel configuration associated with the determined at least one active BWP;
one or more transmission configuration indication (TCI) state configuration associated with the determined at least one active BWP;
one or more TCI state configuration associated with a downlink channel of the target cell;
one or more TCI state configuration associated with an uplink channel of the target cell; and
one or more spatial relation configuration associated with the determined at least one active BWP.

9. The method of claim 8, wherein based on the determination of the at least one active BWP, determining one or more TCI state configuration associated with the determined at least one active BWP further comprises determining a TCI state to be activated based on a TCI state identifier included in the L1/L2 inter-cell mobility execution command.

10. The method of claim 1, further comprising performing one or more measurements on one or more reference signals configured in the determined at least one active BWP.

11. A wireless device capable of layer one (L1)/layer two (L2) inter-cell mobility, the wireless device comprising processing circuitry operable to:
receive a L1/L2 inter-cell mobility configuration comprising at least one target candidate cell configuration, wherein the at least one target candidate cell configuration comprises one or more bandwidth part (BWP) configurations;
obtain at least one indication of at least one of the BWP configurations of a target candidate cell to be activated;
receive a L1/L2 inter-cell mobility execution command including an indication of one target candidate cell configuration for a target cell; and
determine at least one active BWP of the target cell in which the wireless device is to operate in the target cell based on the indicated target candidate cell configuration.

12. (canceled)

13. The wireless device of claim 11, wherein the processing circuitry is operable to obtain the at least one indication of the BWP configurations of the target candidate cell to be activated by receiving the indication in the received L1/L2 inter-cell mobility execution command.

14.-20. (canceled)

21. A method performed by a network node capable of layer one (L1)/layer two (L2) inter-cell mobility, the method comprising:
providing a target candidate cell configuration for L1/L2 inter-cell mobility comprising one or more bandwidth part (BWP) configurations to a wireless device; and
providing at least one indication of at least one of the one or more BWP configurations to be activated to the wireless device.

22. The method of claim 21, wherein providing the at least one indication of the BWP configurations to be activated comprises providing the indication in the target candidate cell configuration.

23. The method of claim 21, wherein providing the at least one indication of the BWP configurations to be activated comprises providing the indication as part of a L1/L2 inter-cell mobility execution command.

24. The method of claim 21, wherein providing the at least one indication of the BWP configuration to be activated comprises providing the indication in a Radio Resource Control (RRC) message.

25. The method of claim 21, wherein the one or more BWP configurations comprise one or more configurations for one or more downlink BWPs, one or more uplink BWPs, and one or more uplink and downlink BWPs.

26. The method of claim 21 wherein the network node comprises a candidate distributed unit (DU) associated with a target candidate cell configured for L1/L2 inter-cell mobility.

27. A network node capable of layer one (L1)/layer two (L2) inter-cell mobility, the network node comprising processing circuitry operable to:
provide a target candidate cell configuration for L1/L2 inter-cell mobility comprising one or more bandwidth part (BWP) configurations to a wireless device; and
provide at least one indication of at least one of the one or more BWP configurations to be activated to the wireless device.

28. (canceled)

29. The network node of claim 27, wherein the processing circuitry is operable to provide the at least one indication of the BWP configurations to be activated by providing the indication as part of a L1/L2 inter-cell mobility execution command.

30.-32. (canceled)
